(19) United States
(12) Patent Application Publication
(10) Pub. No.: US 2026/0289179 A1
(43) Pub. Date: Sep. 24, 2026

(54) SYSTEM

(71) Applicant: SoftBank Group Corp., Tokyo (JP)

(72) Inventor: Kotaro HOSOYAMADA, Tokyo (JP)

(73) Assignee: SoftBank Group Corp., Tokyo (JP)

(21) Appl. No.: 19/567,038

(22) Filed: Mar. 14, 2026

(30) Foreign Application Priority Data
Mar. 19, 2025 (JP) 2025-045227

(51) Int. Cl. G06F 40/40; G06N 3/0475

(52) U.S. Cl. CPC G06F 40/40; G06N 3/0475

(57) ABSTRACT

A system includes a processor that is configured to collect information from a plurality of information sources and construct a training dataset by using a machine learning algorithm, analyze a question from a user by using a natural language processing technique, generate a prompt for instructing a generative AI model to generate an appropriate answer, and input the prompt to the generative AI model, and analyze an emotion of the user, generate a prompt for instructing the generative AI model to adjust a response based on the emotion of the user, and optimize a response to an operator.

### CROSS-REFERENCE TO RELATED APPLICATION

This application is based on and claims priority under 35 USC 119 from Japanese Patent Application No. 2025-045227 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional customer support systems and operator-assist systems suffer from several limitations. First, many systems rely on manually curated scripts or static FAQs, which cannot sufficiently utilize heterogeneous information sources such as product information, site information, communication navigation information, and user interaction logs in an integrated manner. As a result, response content is often incomplete or outdated, and the system cannot promptly reflect newly accumulated knowledge.

Second, known systems that use machine learning or natural language processing typically focus only on question understanding and answer retrieval, and do not adequately generate prompts tailored to generative AI models. Therefore, these systems cannot fully exploit the capabilities of generative AI models to produce context-appropriate, high-quality answers in real time.

Third, conventional systems rarely analyze user emotion in an integrated fashion and do not adjust responses of generative AI models based on emotional states. Consequently, responses are sometimes inappropriate to the user's emotional condition, leading to reduced customer satisfaction and increased operator stress.

Accordingly, there is a need for a system that collects information from multiple information sources, constructs a training dataset using a machine learning algorithm, analyzes user questions by natural language processing, and automatically generates prompts for instructing a generative AI model to generate appropriate answers, while further analyzing user emotion to optimize responses to operators and end users. Such a system should improve response quality, enhance customer satisfaction, and reduce operator stress by enabling rapid and accurate information provision.

### SUMMARY

In order to solve the above problems, a system according to one aspect of the present invention comprises a processor, wherein the processor is configured to collect information from a plurality of information sources and construct a training dataset by using a machine learning algorithm. The processor stores product information, site information, communication navigation information, and user interaction logs in a database and analyzes these stored data by the machine learning algorithm, thereby building and updating a training dataset that reflects practical support cases and diverse types of content.

The processor further analyzes a question from a user by using a natural language processing technique, generates a prompt for instructing a generative AI model to generate an appropriate answer, and inputs the prompt to the generative AI model. By explicitly generating and supplying such prompts, the processor enables the generative AI model to produce answers that are contextually accurate and based on the integrated training dataset.

In addition, the processor analyzes an emotion of the user, for example by applying emotion recognition techniques to textual or other interaction data, and generates a prompt for instructing the generative AI model to adjust a response based on the emotion of the user.

The processor optimizes a response to an operator and/or the end user by causing the generative AI model to modify tone, level of detail, or guidance according to the detected emotional state. Through these operations, the processor contributes to improvement of response quality, improvement of customer satisfaction, and reduction of operator stress, and realizes rapid and accurate provision of information by generating prompts for the generative AI model in an integrated manner.

The term “processor” refers to one or more hardware processing units, such as a central processing unit (CPU), a graphics processing unit (GPU), a digital signal processor (DSP), or any combination thereof, configured to execute instructions and perform the functions described in the claims.

The term “information sources” refers to a plurality of heterogeneous data origins, including but not limited to product information repositories, website content systems, communication navigation configuration systems, and user interaction log systems, from which information is collected by the processor.

The term “training dataset” refers to a structured collection of data samples, generated from information collected from the information sources, which is used by a machine learning algorithm to train or update a model for analysis, prediction, or generation tasks.

The term “machine learning algorithm” refers to a computational method or set of methods that enable a model to automatically learn patterns, relationships, or representations from the training dataset, including but not limited to supervised learning, unsupervised learning, and reinforcement learning techniques.

The term “product information” refers to data relating to products or services, including attributes such as specifications, features, manuals, prices, availability, warranty conditions, and associated metadata, which are stored in a database and analyzed by the processor.

The term “site information” refers to data associated with web-based or application-based content, including FAQs, help pages, policy pages, manuals, and other content published on websites or similar platforms, which is stored in a database and analyzed by the processor.

The term “communication navigation information” refers to data indicating rules, workflows, or configurations for routing or guiding user communications, such as call routing rules, menu hierarchies, escalation paths, and channel selection logic, which are stored in a database and analyzed by the processor.

The term “user interaction logs” refers to records of past interactions between users and a system or operator, including but not limited to chat logs, email records, call transcripts, and other support or communication histories, which are stored in a database and analyzed by the processor.

The term “database” refers to a logical data storage system implemented using one or more physical or cloud-based storage devices, which stores product information, site information, communication navigation information, and user interaction logs in a structured or semi-structured form accessible by the processor.

The term “natural language processing technique” refers to a computational technique or set of techniques for processing, understanding, or transforming human language text, including but not limited to tokenization, part-of-speech tagging, syntactic parsing, semantic analysis, intent detection, and entity recognition.

The term “question from a user” refers to an inquiry expressed by a user in natural language, typically as text or as text derived from speech, which is input to the system and analyzed by the processor using natural language processing.

The term “prompt” refers to a text or structured instruction generated by the processor and provided as input to a generative AI model, the prompt specifying or constraining how the generative AI model should generate an answer or response.

The term “generative AI model” refers to a machine learning model configured to generate content, such as natural language text responses, based on an input prompt and optionally additional context, and including but not limited to large language models and other generative models.

The term “appropriate answer” refers to an output produced by the generative AI model that is relevant to the user's question, consistent with information contained in the training dataset and related sources, and suitable in terms of correctness and context.

The term “user emotion” refers to an emotional state or sentiment of the user, such as satisfaction, frustration, anger, confusion, or calmness, inferred by the processor from textual, vocal, behavioral, or contextual signals in the user's interaction.

The term “adjust a response” refers to modifying one or more attributes of a response generated by the generative AI model, such as tone, politeness level, level of detail, structure, or content emphasis, in accordance with the detected user emotion or other context.

The term “optimize a response to an operator” refers to tailoring the content, form, or timing of information presented to an operator, such as suggested replies, guidance, or supporting information, so as to reduce operator workload, improve clarity, and support effective communication with the user.

The term “response quality” refers to a measure of how well a generated or assisted response satisfies criteria such as accuracy, completeness, relevance, clarity, and appropriateness to the user's question and situation.

The term “customer satisfaction” refers to a level of perceived satisfaction or approval by a user or customer regarding the support or information provided by the system or operator, as reflected in explicit feedback, implicit behavior, or inferred evaluation.

The term “operator stress” refers to a mental or emotional burden experienced by a human operator while handling user interactions, which may be influenced by workload, complexity of inquiries, and adequacy of system support, and which the present system is configured to reduce.

The term “rapid and accurate provision of information” refers to providing users or operators with relevant and correct information within a short response time, by using the processor's functions of collecting, analyzing, and generating prompts for the generative AI model.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

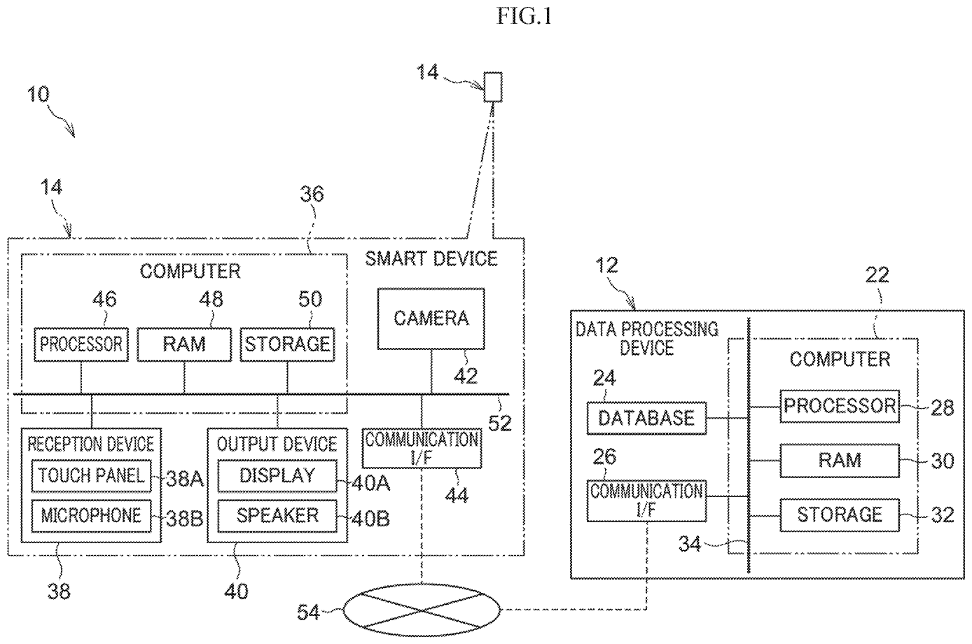

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

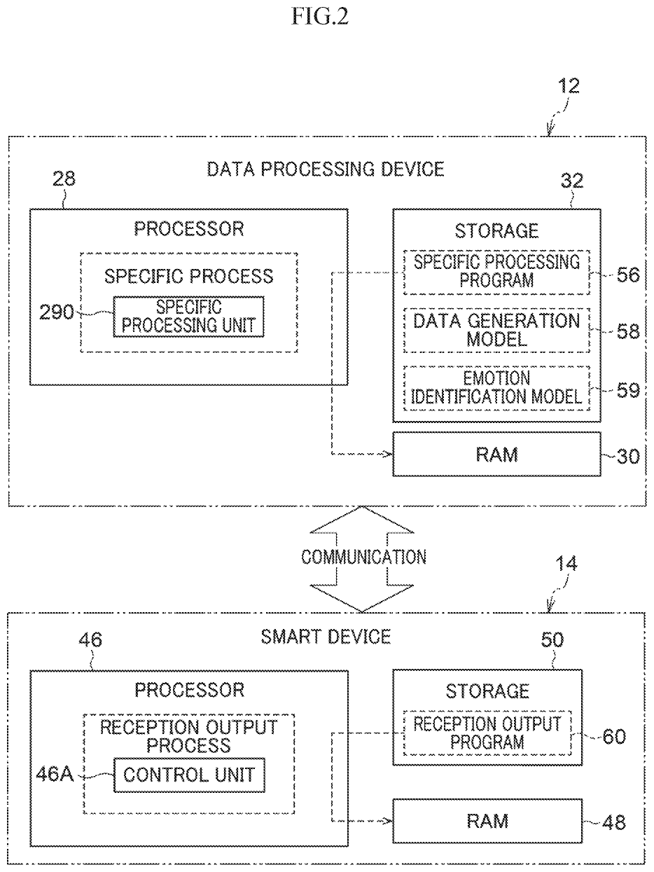

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems and decision-support systems that rely on generative artificial intelligence models have several technical limitations when deployed in real-world environments with heterogeneous enterprise data. First, such systems typically treat the generative artificial intelligence model as a standalone component that receives only a user prompt sentence, without systematic integration of structured data and unstructured data collected from multiple information sources. As a result, the underlying computing system fails to exploit available data resources stored in databases, log repositories, and other storage devices, and the responses produced by the generative artificial intelligence model are often generic, not grounded in current data, and computationally inefficient due to repeated ad hoc retrieval and preprocessing operations.

Second, existing architectures generally perform offline training of machine learning models on static datasets, and do not provide a unified programmatic mechanism to construct training datasets and evaluation datasets through automated preprocessing pipelines that include missing-value completion, normalization, encoding, and feature extraction. This lack of integrated preprocessing leads to fragmented implementations, increased processor load, inconsistent model performance, and difficulty in maintaining reproducible training and evaluation procedures across different computing environments.

Third, conventional systems usually do not incorporate a feedback loop that programmatically measures user reactions and emotional states at the level of the computing substrate, and consequently cannot dynamically adjust prompt sentences or generation conditions supplied to the generative artificial intelligence model based on such feedback. Without this capability, the processor executes inference in a static manner, ignoring rich interaction histories and user operation logs, and therefore cannot systematically optimize response candidates in terms of response quality, customer satisfaction, and operator load. This results in suboptimal utilization of processing resources, prolonged interaction sequences, and unnecessary manual interventions by human operators.

Fourth, many existing solutions do not provide an integrated mechanism to log user prompt sentences, generated response candidates, and estimated user evaluations as structured history data and to reuse this history data within a continuous retraining pipeline for both discriminative models and generative artificial intelligence models. Consequently, the computing system cannot effectively adapt over time to evolving language patterns, changing product information, or new usage scenarios, leading to model degradation, increased maintenance costs, and reduced reliability of automated responses.

Accordingly, there is a need for an improved computer-implemented system and method that (i) unifies acquisition and storage of heterogeneous data from multiple information sources, (ii) performs standardized and automated preprocessing to construct training and evaluation datasets, (iii) tightly integrates learned models and generative artificial intelligence models through automatically generated and dynamically adjusted prompt sentences, and (iv) implements a continuous feedback and retraining loop based on user interaction history and estimated emotional states. Such a system should improve the functioning of the computer itself by reducing redundant computations, enabling more efficient use of processor and memory resources, enhancing the accuracy and relevance of generated responses, and reducing the computational and cognitive load associated with human operator support tasks.

The specific processing by the specific processing unit 290 of the data processing device 12 in Example 1 is realized by the following means.

The present invention provides a server comprising a processor and a storage device, the processor being configured to acquire, via a communication network, structured data and unstructured data from a plurality of information sources and store the acquired data in the storage device; to execute a standardized preprocessing pipeline on the acquired data, the preprocessing pipeline including missing-value completion, normalization, encoding, and feature extraction, thereby generating a training dataset and an evaluation dataset in formats directly consumable by machine learning algorithms; to train, using the training dataset, a learned model including at least one of an identification model and a prediction model based on a machine learning algorithm including deep learning, and to verify the learned model by calculating evaluation indices based on the evaluation dataset; to analyze a prompt sentence expressed in natural language and received from a user, identify a requested task based on the prompt sentence, and extract related data corresponding to the requested task from at least one of the acquired data and the learned model; to automatically generate a prompt sentence to be supplied to a generative artificial intelligence model, the generated prompt sentence including at least part of the user prompt sentence and the extracted related data as input conditions, and to input the generated prompt sentence into the generative artificial intelligence model to cause the generative artificial intelligence model to generate one or more response candidates; to estimate, based on input content from the user and operation history of the user with respect to the response candidates, an emotional state or an evaluation of the user, and dynamically adjust at least one of content of the prompt sentence supplied to the generative artificial intelligence model and generation conditions of the generative artificial intelligence model in accordance with an estimation result so as to optimize the response candidates; to transmit optimized response candidates to a terminal device for presentation of information or operational support to an end user or an operator; and to store, as history data, the user prompt sentence, the response candidates, and the estimated emotional state or evaluation, and reuse the history data in the training dataset to continuously retrain the learned model and the generative artificial intelligence model. This enables improvement of the operation of the computing system by providing a unified, processor-implemented architecture that efficiently integrates heterogeneous data collection, automated dataset construction, task-aware prompt generation, adaptive control of a generative artificial intelligence model based on user feedback, and continuous retraining, thereby enhancing the accuracy, relevance, and responsiveness of system outputs while reducing processing overhead and operator burden.

The term “system” refers to a combination of one or more computing devices, storage devices, and communication interfaces that cooperate to execute programmed instructions to perform data processing, model training, and inference operations.

The term “processor” refers to one or more processing circuits, such as a central processing unit, a graphics processing unit, or a specialized accelerator, configured to execute computer-readable instructions and perform arithmetic, logical, control, and input/output operations.

The term “storage device” refers to any non-transitory computer-readable medium, such as a magnetic disk, optical disk, semiconductor memory, or network-attached storage, configured to store data, models, parameters, logs, and program instructions.

The term “communication network” refers to one or more wired or wireless communication infrastructures, including local area networks, wide area networks, and packet-switched networks, that enable data transmission between the system and external devices or services.

The term “structured data” refers to data that is organized according to a predefined schema, such as tables, records, and fields in a database, and is directly accessible by field names or data types.

The term “unstructured data” refers to data that does not conform to a fixed schema, such as free-form text, documents, or logs, and requires parsing or feature extraction to be used in machine learning.

The term “information source” refers to any hardware or software component, service, or repository that provides data to the system, including databases, log stores, application servers, and external services.

The term “preprocessing” refers to a sequence of data transformation operations applied before model training or inference, including cleansing, normalization, encoding, feature extraction, and dataset construction.

The term “missing-value completion” refers to a processing operation in which absent or null entries in a dataset are replaced with substitute values based on predefined rules, statistics, or learned models.

The term “normalization” refers to a data transformation that scales or standardizes numerical values into a defined range or distribution to improve numerical stability and learning behavior of models.

The term “encoding” refers to a transformation that converts symbolic or categorical data, such as text labels or categories, into numerical representations suitable for machine processing.

The term “feature extraction” refers to a process of deriving informative numerical or symbolic descriptors from raw data to be used as input variables for a machine learning model.

The term “training dataset” refers to a collection of data samples and associated labels or targets used by the processor to adjust parameters of a machine learning model during a training procedure.

The term “evaluation dataset” refers to a collection of data samples and associated labels or targets that is distinct from the training dataset and is used to assess the performance of a trained model.

The term “machine learning algorithm” refers to a computational procedure that adjusts parameters of a model based on data, examples, or feedback, in order to perform tasks such as classification, regression, or prediction.

The term “deep learning” refers to a subset of machine learning techniques that use artificial neural networks with multiple layers of nonlinear processing units to learn complex representations from data.

The term “learned model” refers to a representation, such as a set of parameters or structures, obtained by applying a machine learning algorithm to a training dataset, and configured to perform tasks such as identification or prediction.

The term “identification model” refers to a learned model configured to assign input data to one or more classes, categories, or labels, such as for classification or detection tasks.

The term “prediction model” refers to a learned model configured to estimate future values, probabilities, or outcomes based on input data, such as for forecasting or regression tasks.

The term “evaluation index” refers to a quantitative metric, such as accuracy, precision, recall, F1 score, or error rate, that is calculated to assess the performance of a learned model or system.

The term “prompt sentence” refers to a sequence of characters, tokens, or words expressed in natural language that is supplied by a user or generated by the system to specify a task or request to a generative artificial intelligence model.

The term “user” refers to a human individual or an automated client that interacts with the system by sending prompt sentences, commands, or feedback through a terminal device or interface.

The term “requested task” refers to an operation, analysis, or response type that is inferred by the processor from the content of a prompt sentence, such as classification, explanation, recommendation, or summarization.

The term “related data” refers to a subset of acquired or derived data that is determined by the processor to be relevant to a requested task indicated by a prompt sentence.

The term “generative artificial intelligence model” refers to a machine learning model configured to produce new data samples, such as natural language text, based on given input conditions, including prompt sentences and contextual information.

The term “response candidate” refers to an output produced by the generative artificial intelligence model in response to a prompt sentence, before any selection or optimization is finalized by the system.

The term “emotional state” refers to an estimated affective condition of a user, such as satisfaction, frustration, or neutrality, inferred from user inputs, behavior, or interaction patterns.

The term “evaluation of the user” refers to a measure or assessment, such as a rating or implicit feedback, that indicates the user's perceived quality or usefulness of a response candidate.

The term “operation history” refers to recorded interaction data that describes how a user has operated the system, including actions such as clicks, selections, edits, confirmations, or rejections of response candidates.

The term “generation condition” refers to a parameter or constraint that influences the behavior of a generative artificial intelligence model, such as maximum length, sampling method, or stylistic control.

The term “optimization of the response candidates” refers to a process in which the system selects, modifies, or regenerates response candidates so as to better satisfy specified criteria or estimated user needs.

The term “terminal device” refers to an endpoint computing device, such as a client computer, handheld device, or display device, used by a user or an operator to send inputs to and receive outputs from the system.

The term “end user” refers to a human recipient of information or services provided by the system, other than an operator managing or supervising the system.

The term “operator” refers to a human user responsible for monitoring, managing, or supporting the operation of the system, including handling escalated cases or supervising automated responses.

The term “history data” refers to stored records that include prompt sentences, response candidates, user interactions, estimated emotional states, and evaluations, maintained for auditing, analysis, or retraining purposes.

The term “continuous retraining” refers to a process in which a learned model or a generative artificial intelligence model is periodically or incrementally retrained using newly collected data, including history data, to adapt to changes in usage or data distributions.

The term “product-related information” refers to structured data describing attributes, categories, and states of items or services offered by an organization.

The term “site-related information” refers to data indicating access patterns, usage history, or interaction logs associated with network resources, such as web pages or application endpoints.

The term “communication navigation information” refers to data representing transitions, paths, or flows in communication sequences, such as navigation between pages, screens, or interaction states.

The term “user interaction log” refers to recorded data describing exchanges between a user and the system or between a user and an operator, including messages, timestamps, and contextual metadata.

The term “response-quality index” refers to a metric used to quantify aspects of response performance, such as accuracy, relevance, completeness, or consistency, from the perspective of the system.

The term “customer-satisfaction index” refers to a metric used to quantify a level of satisfaction of end users, inferred from explicit feedback or implicit behavioral indicators.

The term “operator-load index” refers to a metric used to quantify workload or burden on an operator, such as the number of escalations, handling time, or manual interventions required.

The term “predetermined condition” refers to a rule, threshold, or constraint defined in advance, which is used to judge whether evaluation indices or system states are acceptable or require adjustment.

The term “work process” refers to a sequence of tasks, operations, or procedures executed in a business or service context, which is supported or partially automated by the system.

The term “user experience” refers to an overall perception and effectiveness of the interaction between a user and the system, including ease of use, responsiveness, and perceived quality of results.

In one embodiment, a server includes a processor, a main memory, a non-transitory storage device, and a network interface. The server runs an operating system such as a general-purpose server operating system, and executes application software implemented, for example, in a high-level programming language. The server uses software libraries for data processing, such as a tabular-data processing library and a numerical-computation library, and uses machine learning frameworks such as a deep learning framework based on tensor operations. The server further uses a web framework to provide an application programming interface (API) for communication with a terminal.

The terminal includes a processor, a display, an input device, and a communication interface.

The terminal runs a client application, such as a web browser or a dedicated native application, which communicates with the server via a communication network using a protocol such as HTTPS. The terminal presents graphical user interface components that allow a user to input a prompt sentence and to view generated analysis results.

The user operates the terminal to input prompt sentences and to view and react to response candidates generated on the server. The user may be an operator, a business analyst, or an end user, and interacts with the system by entering natural-language text, selecting options, and giving feedback such as ratings or follow-up questions.

The server acquires structured data and unstructured data from multiple information sources.

As one example, the server connects to a relational database management system that stores product-related information, site-related information, communication navigation information, and user interaction logs. The server issues structured query language commands via a database driver to retrieve tabular data. As another example, the server connects to external log storage or analytics services via a web service interface, and acquires usage logs in formats such as comma-separated values or JavaScript object notation. The server stores the acquired data in the storage device as datasets organized by logical tables, each table including fields such as timestamps, user identifiers, resource identifiers, and categorical event types.

The server executes a standardized preprocessing pipeline implemented with the tabular-data processing library and the numerical-computation library. The server loads raw datasets into in-memory data structures such as data frames. The server executes missing-value completion by scanning individual columns to detect null entries and replacing those entries with statistical estimates (for example, medians or modes) or domain-specific sentinel values. The server executes normalization by applying mathematical transformations to numerical features, such as subtracting a column-wise mean and dividing by a standard deviation, thereby producing standardized feature values that improve the convergence behavior of gradient-based learning algorithms. The server executes encoding by transforming categorical attributes, such as product categories or communication channel types, into numerical vectors using one-hot encoding or ordinal encoding. The server executes feature extraction by computing derived features, for example: session duration from time-stamped events; navigation depth from sequences of page transitions; or frequency counts of user actions.

These operations produce fixed-length feature vectors that are more suitable for training machine learning models than the original raw data.

The server generates a training dataset and an evaluation dataset by partitioning the preprocessed data. The server may use temporal constraints to ensure that evaluation data represents more recent periods than training data, which reduces information leakage and better reflects real-world deployment scenarios. The server stores these datasets in binary formats optimized for rapid loading, such as array-based binary formats, thereby reducing disk input/output overhead and improving training speed.

The server trains a learned model by using a machine learning framework. In one embodiment, the server constructs a deep neural network that includes an input layer corresponding to the extracted feature vectors, one or more hidden layers such as fully connected layers with non-linear activation functions, and an output layer producing a probability distribution over classes or a numerical prediction. The server defines a loss function such as cross-entropy loss for classification or mean squared error for regression.

The server selects an optimization algorithm such as an adaptive gradient-based optimizer, and sets hyperparameters including learning rate, batch size, and number of training epochs.

The server executes forward propagation by computing, for each mini-batch of input feature vectors, matrix multiplications and non-linear activations through the network layers on a processor or an attached accelerator such as a graphics processing unit. The server computes the loss value by comparing the network outputs with ground-truth labels. The server executes backpropagation by calculating gradients of the loss with respect to the model parameters using automatic differentiation provided by the machine learning framework. The server updates the model parameters in the direction indicated by the gradients scaled by the learning rate. These operations are repeated over the training dataset. The server evaluates the trained model on the evaluation dataset by computing evaluation indices such as accuracy, precision, recall, and F1 score. The server stores the trained model as a parameter file in the storage device.

The server constructs a generative AI model as a separate component. In one embodiment, the generative AI model is implemented as a transformer-based neural network for text generation. The server loads a tokenizer module that maps characters or words to integer token identifiers, and constructs an embedding layer that maps token identifiers to dense vector representations. The server arranges a stack of attention blocks including multi-head self-attention layers, feed-forward layers, layer-normalization layers, and residual connections. The server defines a language modeling objective, such as next-token prediction, and trains or fine-tunes the generative AI model on domain-specific text corpora that include product descriptions, support dialogs, and internal knowledge-base content. The server uses a loss function such as categorical cross-entropy over output tokens, and an optimizer analogous to the one used for the learned model. The server stores the trained generative AI model in the storage device and loads it into main memory for inference.

The server integrates the learned model and the generative AI model by generating and adjusting prompt sentences. The server receives a prompt sentence from the user via the terminal. For example, the user may input the following prompt sentence:

“Using recent customer interaction logs and product information, explain why the return rate has increased for our latest smartphone model.”

In another example, the user may input:

“Please propose three improvements to our website flow to increase conversions from product detail pages to checkout.”

In yet another example, the user may input:

“Based on customer purchase history and support records, identify two promising target segments for our new subscription service and justify each choice.”

The server parses the user's prompt sentence using a natural language processing module that performs tokenization, part-of-speech tagging, and intent classification. The server applies a classification model or rule-based logic to determine a requested task type, such as causal analysis, website optimization, or customer segmentation. The server uses this classification to query the preprocessed data or the outputs of the learned model. For example, for the return-rate analysis prompt, the server retrieves feature distributions related to defect reports, shipping delays, and firmware version identifiers, and computes statistical correlations between these features and return events by executing numerical computations such as correlation coefficients or logistic regression analysis.

The server constructs an internal representation of related data, such as a compact textual summary or a structured list of key metrics. The server then generates a system-level prompt sentence that incorporates both the original user prompt sentence and the extracted related data. For example, the server may generate:

“You are an analytical assistant. The following metrics were computed from internal logs: defect reports for model X increased by 35% in the last month, shipping delays occurred in 18% of deliveries, and battery-related complaints account for 52% of support tickets. Based on these metrics, respond to the following request: Using recent customer interaction logs and product information, explain why the return rate has increased for our latest smartphone model.”

The server encodes this generated prompt sentence with the tokenizer and provides the token sequence to the generative AI model as input, along with generation parameters such as maximum number of tokens, temperature, and sampling strategy. The generative AI model performs a series of attention and matrix-multiplication operations to compute probability distributions over next tokens and generates a response candidate as a sequence of tokens.

The server decodes the tokens into text and obtains a natural-language explanation.

The server estimates an emotional state or evaluation of the user by analyzing the user's subsequent interactions. For example, the server monitors whether the user requests a follow-up clarification, rejects the answer, or quickly accepts the recommended actions. The server may also allow the user to input explicit feedback such as a rating. The server encodes such interaction signals into numerical features and applies a small neural network or a logistic regression model to infer a satisfaction score or an emotional state category. The server uses this estimation to adjust future prompt sentences. For instance, if the user shows dissatisfaction when the response is overly technical, the server modifies the system-level portion of the prompt sentence to instruct the generative AI model to produce more concise, less technical explanations. The server may also adjust generation parameters such as temperature to reduce verbosity or increase determinism.

The server transmits optimized response candidates to the terminal over the communication network using protocols such as HTTPS. The terminal receives the response in structured form and renders the text and any associated numerical summaries or charts. The user views the response and may input another prompt sentence, creating an interactive loop.

The server stores, in the storage device, history data that includes user prompt sentences, generated response candidates, interaction logs such as clicks and edits, and estimated emotional states or evaluations. The server periodically aggregates this history data into new training datasets. For the learned model, the server includes new labeled examples derived from operator-confirmed correct outcomes or from implicit feedback signals. For the generative AI model, the server uses human-rated responses or highly rated interactions as additional fine-tuning data, and may apply techniques such as supervised fine-tuning or preference-based optimization. By updating model parameters over time, the server adapts to evolving user behavior and changes in the underlying data distribution.

The described architecture improves computer technology in several concrete ways. The server reduces redundant preprocessing by standardizing the pipeline; this avoids repeated ad hoc cleaning and transformation and allows reuse of intermediate representations. As a result, the server reduces processor time and memory usage for each training and inference cycle.

The server improves response accuracy because the generative AI model receives prompt sentences that embed structured, statistically derived context rather than raw text alone. This reduces hallucinations and increases grounding in actual database values. The server improves data management by maintaining consistent feature definitions and dataset partitions, which simplifies model comparison and reduces errors due to inconsistent schemas.

The server improves computation efficiency by using compact feature vectors and binary dataset formats, which are optimized for vectorized operations and fast sequential access. The server further reduces communication load by performing aggregation and analysis on the server side and transmitting only summarized results to the terminal, rather than raw logs or full datasets. This decreases network bandwidth usage and improves response time for the user.

The server uses machine learning algorithms and deep neural networks in ways that differ from simple human emulation. For example, the server executes gradient-based optimization in high-dimensional parameter spaces, using loss functions and regularization methods that have no direct human analog. The server applies non-obvious prompt-construction rules that combine statistical outputs from the learned model with task-specific meta-instructions, which are generated algorithmically rather than by static templates. These combinations are selected to exploit the generative AI model's internal attention mechanisms and to emphasize relevant feature patterns in a way that a human operator could not manually maintain at scale.

In alternative embodiments, the server may replace the transformer-based generative AI model with a recurrent neural network model or a sequence-to-sequence model with attention. The server may also vary the architecture of the learned model, for example by using gradient-boosted decision trees for tabular prediction tasks or graph neural networks for communication-path analysis. The preprocessing pipeline may include additional operations such as outlier detection using clustering algorithms, or dimensionality reduction using principal component analysis or autoencoders. The emotional-state estimation may use different model types, such as convolutional neural networks applied to text segments of user comments.

In another embodiment, the server may control auxiliary devices based on generated responses. For example, the server may adjust scheduling parameters of backend batch-processing jobs or may change caching policies in a content-delivery subsystem according to detected traffic patterns derived from the site-related information and communication navigation information. In such cases, the improved predictions and adaptive prompt-based analysis reduce cache misses and latency, thereby directly improving the technical performance of networked computing resources.

Through these embodiments, the server, terminal, and user cooperate in a system in which the generative AI model is coupled to structured and unstructured data via dynamically generated prompt sentences, and where feedback from the user is incorporated into continuous retraining of both discriminative models and generative models. The combination of standardized preprocessing, model training, adaptive prompt generation, and feedback-driven optimization yields technical effects including increased prediction accuracy, faster response generation, reduced computational overhead, and improved management of heterogeneous data resources within the computing environment.

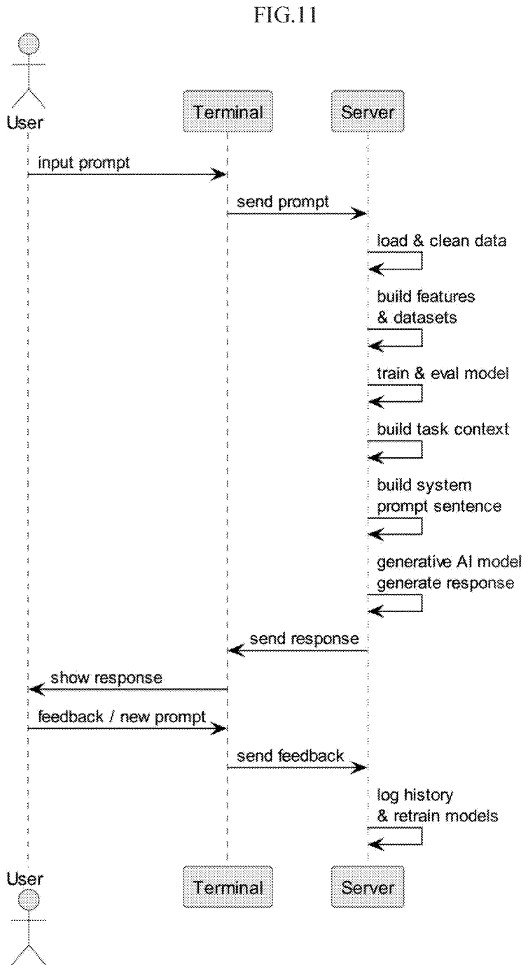

The following describes the processing flow using FIG. 11.

### Step 1

The server acquires raw data from multiple information sources. The server receives as input connection parameters, such as database connection strings, API endpoints, and authentication credentials. The server sends structured queries to database systems and HTTP requests to external services, and receives as output structured records (for example, tables of product attributes, site usage logs, communication path logs, and user interaction logs) and unstructured records (for example, free-text comments and dialog transcripts). The server writes these records to a storage device as raw data files or tables.

### Step 2

The server loads the raw data into an in-memory processing environment. The server takes as input the raw data files or tables stored in the storage device. The server invokes a data-processing library to read tabular formats into data-frame structures and to parse text formats into line-based or document-based structures. As output, the server generates in-memory data objects representing each information source, with columns such as timestamps, identifiers, event types, and text fields.

### Step 3

The server performs data cleaning on the loaded data. The server receives as input the in-memory data objects. The server scans each column to detect missing or invalid values, removes duplicate records based on key fields, and corrects inconsistent types (for example, converting string-formatted numbers to numeric types). The server applies statistical rules to fill missing values (for example, replacing null numerical values with the median and null categorical values with the most frequent category). As output, the server produces cleaned data objects with consistent schemas and reduced noise.

### Step 4

The server executes normalization and encoding to generate feature-ready data. The server takes as input the cleaned data objects. The server selects numerical columns and computes column-wise statistics such as mean and standard deviation, then transforms each value using a standardization formula. The server selects categorical columns, constructs category dictionaries, and encodes each category into binary or integer-coded vectors. The server also derives additional features, such as session duration from ordered timestamps or navigation depth from sequences of page transitions. As output, the server produces feature matrices, where each row corresponds to an event or entity and each column corresponds to a normalized or encoded feature.

### Step 5

The server splits the feature matrices into datasets for training and evaluation. The server receives as input the feature matrices and, when available, associated labels such as return occurrence, conversion occurrence, or segment identifiers. The server applies partitioning logic, for example by dividing based on time ranges or by random stratified sampling, to separate the data into a training dataset and an evaluation dataset. As output, the server stores these datasets as binary matrices or tensor files, each annotated with metadata indicating its role (training or evaluation).

### Step 6

The server trains a learned model on the training dataset. The server takes as input the training dataset and a model configuration specifying network architecture, loss function, optimizer, and hyperparameters. The server initializes model parameters, then iteratively processes batches of training examples: the server performs forward propagation by multiplying input feature vectors by weight matrices and applying non-linear activation functions, computes a loss value by comparing model outputs with ground-truth labels, and performs backpropagation to calculate gradients of the loss with respect to the parameters. The server updates the parameters using the optimizer rules. As output, the server generates a trained model object with learned weight matrices and bias vectors stored in parameter files.

### Step 7

The server evaluates the trained model using the evaluation dataset. The server receives as input the trained model and the evaluation dataset. The server disables parameter updates and performs forward propagation on evaluation samples to obtain predicted labels or scores. The server compares predictions with true labels and calculates evaluation indices such as accuracy, precision, recall, and F1 score. As output, the server generates evaluation reports that include metric values and optional diagnostic data such as confusion matrices.

### Step 8

The server initializes a generative AI model for text generation. The server takes as input a model specification, including vocabulary size, number of layers, attention heads, and embedding dimensions, and optionally pre-trained parameters. The server constructs a tokenizer mapping characters or words to integer tokens and instantiates a neural network with embedding layers, attention blocks, and output projection layers. The server loads trained or fine-tuned parameters into this network. As output, the server maintains an in-memory generative AI model object that can accept token sequences and produce token distributions for response generation.

### Step 9

The terminal presents a user interface to collect a prompt sentence. The terminal receives as input user keyboard events or touch input through a text field component. The terminal displays a cursor and captures the sequence of characters entered by the user. When the user activates a submission control (for example, a send button), the terminal packages the prompt sentence and context information (such as user identifier and current view) into a request message. As output, the terminal sends the request message to the server via a communication network.

### Step 10

The server parses and classifies the incoming prompt sentence. The server receives as input the request message containing the user's prompt sentence and context. The server applies a text-processing module to tokenize the prompt, detect language, and extract key phrases. The server uses a classification model or rule set to map the prompt to a requested task type, for example, “return rate explanation,” “website flow optimization,” or “segment discovery.” As output, the server generates a task descriptor that indicates the task type and extracts relevant parameters such as product identifiers or time ranges.

### Step 11

The server retrieves related data corresponding to the requested task. The server takes as input the task descriptor and the stored feature matrices or aggregated statistics. The server executes filtered queries on the feature matrices based on conditions such as product identifier or date interval, and performs data aggregation operations such as grouping, counting, averaging, or computing correlation coefficients. For example, for a return-rate analysis, the server computes defect-report frequency, shipping-delay ratios, and distribution of complaint categories. As output, the server produces a compact set of related metrics and summaries represented as numerical vectors and human-readable text snippets.

### Step 12

The server constructs a system-level prompt sentence for the generative AI model. The server receives as input the original user prompt sentence and the related metrics and summaries. The server formats a combined text that includes an instruction segment, a data-summary segment, and the original user question. The server may, for example, prepend text such as “You are an analytical assistant” and embed a bullet list of computed metrics before appending the user prompt. As output, the server generates a composite prompt sentence that encodes both the user's request and the system-derived context.

### Step 13

The server encodes the composite prompt and generates response candidates using the generative AI model. The server takes as input the composite prompt sentence and a set of generation parameters such as maximum token length, temperature, and sampling strategy. The server applies the tokenizer to convert the prompt into a sequence of token identifiers, then feeds this sequence into the generative AI model. The generative AI model computes, layer by layer, attention-weighted representations and probability distributions over possible next tokens. The server repeatedly samples or selects tokens according to the configured strategy until a termination condition is met. As output, the server decodes the generated token sequence into one or more response candidate texts.

### Step 14

The server estimates the user's emotional state or evaluation based on interaction history. The server receives as input past interaction logs for the user, including previous prompt sentences, response candidates, user actions such as clicks or follow-up queries, and available explicit ratings. The server transforms these logs into feature vectors, for example by counting accepted responses, rejected responses, and time intervals between response presentation and next action. The server applies an emotional-state model, such as a small neural network or logistic regression, to map these features to an estimated satisfaction score or discrete emotional category. As output, the server produces an estimate of the current user evaluation and a confidence value.

### Step 15

The server adjusts future prompt construction and generation conditions using the estimated evaluation. The server takes as input the estimated emotional state and the current response candidates. If the estimated state indicates dissatisfaction or low confidence, the server modifies the system-level prompt templates to request more detailed or more concise explanations, to simplify technical terminology, or to include alternative options. The server also adjusts generation parameters, such as reducing randomness to increase consistency or increasing maximum length to allow more thorough explanations. As output, the server updates configuration values and, if needed, regenerates improved response candidates using the modified prompts and parameters.

### Step 16

The server transmits optimized response candidates to the terminal. The server receives as input the final selected or regenerated response texts and associated metadata such as confidence scores or key metrics referenced in the explanation. The server packages this information into a response message and sends it through the communication network. As output, the terminal receives the message and is prepared to display the content.

### Step 17

The terminal renders the received response for the user. The terminal takes as input the response message containing response texts and optional structured data. The terminal updates its user interface by displaying the generated explanations, recommendations, or analyses in text areas, and by optionally rendering numerical metrics in tables or charts. The terminal may highlight key phrases or present action buttons such as “helpful” or “needs refinement.” As output, the terminal provides a visual presentation that the user can read and interact with.

### Step 18

The user reviews the response and provides feedback. The user receives as input the displayed response text and any visual elements. The user may, for example, click a feedback button, enter a short assessment, or submit a follow-up prompt sentence to refine the analysis. As output, the user generates new interaction events, such as ratings or additional prompt sentences, which the terminal sends back to the server.

### Step 19

The server records interaction history for continuous learning. The server receives as input the user's feedback events, including ratings, corrections, or subsequent prompts, along with the corresponding response candidates that were shown. The server logs these records to the storage device as history data, associating each prompt with the generated responses and the user's reactions. The server periodically aggregates this history data into new training sets for both the learned model and the generative AI model. As output, the server maintains updated datasets that capture evolving user behavior and model performance.

### Step 20

The server retrains or fine-tunes models using accumulated history data. The server takes as input the aggregated history-derived datasets and current model parameters. For the learned model, the server adds new labeled examples or reweights samples based on user feedback. For the generative AI model, the server performs additional supervised fine-tuning on pairs of prompts and highly rated responses, or applies ranking-based optimization using preference information. The server executes training cycles analogous to those in the initial training phase, adjusting parameters through gradient descent based on newly defined loss functions that incorporate user satisfaction. As output, the server produces updated models that improve prediction accuracy and response quality in subsequent interactions.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation and support systems suffer from several technical deficiencies in how they process and utilize interaction data in real time. Typical architectures treat recommendation logic, natural language response generation, and conversation support as independent subsystems, each operating on static or batch-updated datasets. As a result, these systems are unable to react promptly to rapidly changing user behavior, cannot effectively reuse behavior logs and conversational context as machine-interpretable training data, and often require manual rule tuning for each new usage scenario. This leads to inefficient utilization of processing resources, latency in generating relevant outputs, and limited scalability when the number of users, items, and interaction channels increases.

In many existing systems, user behavior logs are merely stored as historical records and are not systematically converted into structured feature data suitable for continuous machine learning. Natural language models, when present, are typically invoked with ad-hoc input text, without a unified mechanism to generate context-rich prompt sentences that integrate machine-learned behavioral features, recommendation candidates, and conversation signals such as sentiment or intent. Consequently, the generative models cannot exploit the full spectrum of available machine-readable context, which degrades the quality and stability of their outputs.

Furthermore, conventional support tools for human operators do not tightly couple low-level signal processing (for example, speech recognition and emotion detection) with higher-level recommendation models and generative models. Audio and text streams are processed separately from recommendation components, and any suggested responses or supplemental information are often generated using fixed templates or heuristics rather than dynamically optimized prompts. This disjoint processing causes additional network round trips, redundant computation, and suboptimal caching and scheduling of model inference workloads. Another technical problem lies in updating the underlying models. In many systems, the process of retraining or updating recommendation models and prompt generation logic is performed offline, on manually curated datasets, at coarse time intervals. New user selections and purchase operations are not automatically fed back into a continuous learning loop. This leads to a mismatch between the latest observed behavior patterns and the models' internal representations, causing stale recommendations, increased error rates in predicted user intent, and a need for frequent human intervention to recalibrate the system.

Accordingly, there is a need for a computer-implemented system that: (i) unifies multi-source log collection, preprocessing, and feature generation into a single pipeline optimized for machine learning; (ii) programmatically generates structured prompt sentences that embed machine-learned features, recommendation candidates, and conversation analysis results for input to a generative AI model; (iii) integrates speech recognition and emotion analysis directly into the runtime decision loop for recommendation and response generation; and (iv) automatically reuses accumulated behavior history as additional training data to update both recommendation models and prompt generation logic. By addressing these issues, the invention aims to improve the technical functioning of the server-side processing architecture itself, including reduced latency, more efficient use of compute and memory resources, and more accurate, context-aware outputs with minimal manual configuration.

The specific processing by the specific processing unit 290 of the data processing device 12 in Application Example 1 is realized by the following means.

The present invention provides a server comprising a processor configured to collect, from a plurality of information sources, information including behavior history information and attribute information, execute preprocessing and feature generation processing on the collected information to construct a training data set, and train a machine learning model for estimating recommendation target items based on the training data set; to acquire, from a terminal, a user question and a conversation history, execute natural language processing based on the user question and the conversation history, generate and input a prompt sentence for causing a generative AI model to generate an answer text, and output the answer text obtained from the generative AI model to the terminal; to acquire, from the terminal, a user behavior history and a current browsing status, calculate candidate recommendation target items by using the machine learning model, generate a prompt sentence including the candidate recommendation target items and a user behavior summary, input the prompt sentence into the generative AI model, and generate a recommendation target item list based on explanation information or ranking information acquired from the generative AI model; to acquire conversation information in a voice format or a text format, execute speech recognition processing and emotion analysis processing to estimate intentions and emotional states of a user and a responder, generate a prompt sentence including an estimation result, input the prompt sentence into the generative AI model, and present response candidates and supplementary information acquired from the generative AI model on a display screen for the responder; to transmit the recommendation target item list and the answer text as structured information to the terminal, provide, on the terminal, recommendation information and response information visually presented to the user, and store user selection operations and purchase operations as behavior history; and to execute, periodically or under a predetermined condition, an update process in which the stored behavior history is used as an additional training data set and is reflected in the machine learning model and in a prompt generation logic for the generative AI model. This enables an integrated server-side processing architecture in which multi-source log data are automatically converted into machine-learning-ready features, recommendation inference and generative AI inference are coordinated through structured prompt sentences, speech and emotion signals are incorporated into real-time decision making, and newly accumulated behavior history continuously improves the underlying models, thereby reducing processing latency, improving resource efficiency, and enhancing the accuracy and context-awareness of the system's outputs.

The term “processor” refers to a hardware or virtual processing unit, such as a central processing unit or an execution core in a computing environment, that executes instructions to perform data collection, analysis, model training, inference, and communication operations described in the system.

The term “information source” refers to any hardware or software component, storage system, or service that provides data, including but not limited to logs, records, and configuration data used for behavior analysis and recommendation.

The term “behavior history information” refers to data representing past actions of a user or responder, including interactions such as page views, selections, clicks, purchases, searches, and conversation exchanges.

The term “attribute information” refers to descriptive data associated with a user, item, or environment, including identifiers, categories, preferences, demographic information, item properties, and contextual metadata.

The term “preprocessing” refers to a sequence of data transformation operations, including cleaning, normalization, aggregation, and encoding, that convert raw data into a structured form suitable for machine learning and analysis.

The term “feature generation processing” refers to operations that derive numerical or categorical features from raw or preprocessed data, including statistics, counts, time-based measures, and categorical encodings used as inputs to a machine learning model.

The term “training data set” refers to a structured collection of labeled or unlabeled examples, each including one or more features derived from behavior history information and attribute information, used to train or update a machine learning model.

The term “machine learning model” refers to a parameterized computational model, such as a regression model, classification model, or neural network, that is trained using a training data set to estimate or predict recommendation target items or other outputs.

The term “recommendation target item” refers to an entity to be recommended to a user, such as a product, content, or service, that is selected or ranked by the machine learning model and/or generative AI model based on user behavior and context.

The term “terminal” refers to an endpoint device or client application, such as a user terminal or responder terminal, that exchanges data with the server, presents information to users or responders, and captures user inputs or operations.

The term “user question” refers to a natural language query, request, or statement received from a user via the terminal, which is processed by the system to generate an answer text.

The term “conversation history” refers to a sequence of prior messages, utterances, or exchanges between a user and a responder, or between a user and the system, used as context for natural language processing and response generation.

The term “natural language processing” refers to computational techniques that analyze, interpret, or transform text representing human language, including tokenization, parsing, intent detection, and semantic analysis.

The term “prompt sentence” refers to a structured input text, including instructions, context, and data elements, that is generated by the processor and provided to a generative AI model to guide the model's output.

The term “generative AI model” refers to a trained model, such as a generative language model or other generative model, that receives a prompt sentence and generates new content, including answer texts, explanations, or rankings.

The term “answer text” refers to a natural language output generated by the generative AI model in response to a user question and conversation history, and returned to the terminal for presentation to the user.

The term “current browsing status” refers to information indicating the user's present interaction context on the terminal, including currently viewed items, pages, categories, and recent interaction events within a session.

The term “candidate recommendation target item” refers to an item selected or scored by the machine learning model as a potential recommendation prior to final selection or refinement by the generative AI model.

The term “user behavior summary” refers to a condensed representation of a user's past and/or current behaviors, including key patterns, preferences, and interaction statistics, used as part of the prompt sentence.

The term “recommendation target item list” refers to an ordered or unordered collection of recommendation target items generated by the processor based on outputs from the machine learning model and generative AI model.

The term “explanation information” refers to natural language text or structured data that describes the reasons, context, or rationale for recommending specific recommendation target items.

The term “ranking information” refers to data indicating an order or priority among candidate recommendation target items, such as scores, ranks, or categories produced by a model.

The term “conversation information” refers to data representing a communication between a user and a responder or system, including audio signals, transcribed text, or chat messages.

The term “speech recognition processing” refers to computational procedures that convert audio input, such as spoken language, into corresponding text data.

The term “emotion analysis processing” refers to computational procedures that estimate emotional states or attitudes, such as satisfaction, frustration, or neutrality, from text, audio, or other signals.

The term “intention” refers to an inferred purpose, goal, or desired outcome of a user or responder as determined from conversation information, behavior history, or contextual data.

The term “emotional state” refers to an estimated affective condition of a user or responder, derived from emotion analysis processing on conversation information or other signals.

The term “responder” refers to a human operator, agent, or automated support component that communicates with a user, and whose responses may be assisted or supplemented by the system.

The term “response candidate” refers to a proposed reply or message generated by the generative AI model based on a prompt sentence, intended for possible use by a responder.

The term “supplementary information” refers to additional data, such as item details, policy summaries, or procedural guidance, provided alongside response candidates to support a responder or user.

The term “display screen for the responder” refers to a visual output interface on a terminal used by a responder, on which response candidates, supplementary information, and conversation context are presented.

The term “structured information” refers to data organized in a defined format, such as a record or message including identifiers, fields, and values, that can be programmatically parsed and processed by the terminal or server.

The term “user selection operation” refers to an input action by a user, such as choosing an item, clicking an element, or confirming a suggestion, performed via the terminal and recorded as behavior history.

The term “purchase operation” refers to a sequence of user actions associated with acquiring an item, including adding an item to a transaction, confirming payment, or completing an order via the terminal.

The term “update process” refers to a set of computational steps that modify or retrain the machine learning model and adjust prompt generation logic based on new behavior history or other data.

The term “additional training data set” refers to a subset of data, derived from newly accumulated behavior history and other information, that supplements an existing training data set for model updating.

The term “prompt generation logic” refers to rules, templates, and algorithms used by the processor to construct prompt sentences, including selection and formatting of content to be provided to the generative AI model.

The term “information storage device” refers to a memory or storage component, such as a database, file system, or other non-transitory storage medium, used to store information related to items, environments, communication paths, and response histories.

The term “usage environment” refers to contextual conditions under which the user or terminal operates, including device type, network conditions, location context, and interface settings.

The term “communication path” refers to a logical or physical route over which data are transmitted between the terminal and the server, including network connections and protocols.

The term “response history” refers to stored records of previous responses, interactions, or support sessions, including content of replies, timing, and associated outcomes.

The term “analysis processing by a machine learning algorithm” refers to computational operations that apply a trained or training machine learning model to input data to derive patterns, predictions, classifications, or scores.

The term “response quality” refers to a measure of how appropriate, accurate, and helpful a system's or responder's outputs are relative to user needs and context.

The term “user satisfaction” refers to an estimated degree of user approval, comfort, or perceived usefulness regarding system outputs and interactions.

The term “responder load” refers to a measure of workload or cognitive burden on a responder, including effort required to generate responses, search for information, and manage multiple interactions.

The term “real-time information provision” refers to the generation and delivery of outputs, such as recommendations and responses, with latency sufficiently low to be perceived as immediate or near-immediate during ongoing user interactions.

The term “high-accuracy information provision” refers to the delivery of outputs that closely match predicted user needs or intents, as measured by prediction quality, relevance metrics, or observed interaction outcomes.

In one or more embodiments, a server, one or more terminals, and one or more users cooperate to implement the claimed system. The server executes a program stored in a non-transitory computer-readable medium. The program, when executed by a processor of the server, causes the server to perform multi-stage data processing, machine learning model training and inference, prompt sentence generation for a generative AI model, and bidirectional communication with the terminals.

The server is implemented, for example, as one or more virtual machines or physical machines in a data center. The server includes at least one central processing unit (CPU), a main memory, a non-volatile storage device, and, in some embodiments, at least one graphics processing unit (GPU) configured to accelerate numerical computation. The server executes an operating system such as a general-purpose server operating system, and executes application software including a web application framework, a data processing library, and machine learning frameworks such as TensorFlow or PyTorch.

The terminal is implemented, for example, as a personal computer, a smartphone, a tablet, or a dedicated operator console. The terminal includes a CPU, a memory, a display unit, an input unit such as a keyboard or a touch screen, and, in some embodiments, a microphone and a speaker. The terminal executes a web browser or native application that communicates with the server over a network using HTTP, HTTPS, WebSocket, or other communication protocols.

The user operates a terminal to browse items, submit questions, and perform selection operations or purchase operations. The terminal sends user operations and context information to the server. The server processes these inputs and returns recommendation information and response information in a structured format, which the terminal renders on the display.

In a first embodiment, the server uses a data acquisition module to collect information from a plurality of information sources. The server uses a storage interface library (for example, a cloud object storage SDK and a relational database driver) to read log data and master data from a storage system such as a distributed object store and a relational database. The server acquires behavior history information including page view logs, click logs, search logs, and order logs; attribute information including user profile attributes and item attributes; and system context information including device attributes and network attributes.

The server uses a data preprocessing module to apply a predefined sequence of transformations to the acquired information. The server represents each raw record as a structured record object containing fields such as a user identifier, an item identifier, a timestamp, an event type, and numeric attributes. The server detects missing values in specific fields and replaces them using statistical values (for example, category-wise mean or median) computed by a numerical computation library such as NumPy. The server normalizes numeric features such as prices, counts, and time intervals using a scaling formula, and encodes categorical values such as identifiers and categories into integer indices using dictionary mappings stored in the storage device.

The server uses a feature generation module to compute higher-level features tailored for a recommendation task. The server aggregates user-centric statistics such as a number of item interactions per category, a frequency of repeat purchases, and a distribution of price ranges.

The server aggregates item-centric statistics such as a number of unique users who interacted with an item and a conversion ratio. The server encodes temporal patterns, including recency of last interaction and periodicity of access, into numeric features. The server stores the generated feature vectors in a training data table in a database or in feature files in the object store.

In one embodiment, the server uses TensorFlow to define a recommendation machine learning model as a multi-layer neural network. The server concatenates a user feature vector and an item feature vector into a joint feature vector. The server applies an embedding layer to convert high-cardinality categorical indices into dense vectors; applies multiple fully connected layers with non-linear activation functions such as rectified linear units; and outputs a predicted score representing a probability that the user will select or purchase the item. The server trains this neural network using a loss function such as binary cross-entropy or pairwise ranking loss. The server uses an optimization algorithm such as Adam to update the model weights. The server computes gradients by backpropagation through the network and stores updated weights in the storage device.

The server periodically or under predetermined conditions retrains the machine learning model. The server uses newly accumulated behavior history as additional training data. The server may apply data augmentation procedures, such as negative sampling for non-clicked items or time-window resampling, to improve generalization. By continuously updating the model with recent data, the server reduces prediction error and adapts to shifting user preferences.

In a second embodiment, the server integrates a generative AI model through a generative model interface module. The server accesses the generative AI model, for example a large language model provided by a remote inference service or a locally hosted model, via an application programming interface. The server does not treat the generative AI model as a black box; instead, the server controls the context and structure of the input through a prompt generation module. The server constructs a prompt sentence that includes system instructions, user behavior summaries, recommendation candidate information, and conversation context in a predefined format.

The server generates, for example, a prompt sentence of the following type:

“Based on the user's past purchase history and browsing logs, recommend the top 10 products that the user is most likely to purchase next. Return the result as a list with a short explanation for each product.”

The server also generates, in another example, a prompt sentence of the following type:

“You are a customer support assistant for an online shop. Answer the following user question using the provided product and FAQ information. Be concise and friendly. User question: [user_question]. Context: [retrieved_documents].”

The server may further generate a prompt sentence for operator support, such as:

“You are assisting a human operator in real time. The following is the ongoing conversation between the user and the operator. Suggest 2-3 short reply candidates in English for the operator, and list any relevant products. Conversation: [conversation_log].”

The server uses a natural language processing module to analyze the user question and conversation history before constructing the prompt sentence. The server segments the text into tokens, performs part-of-speech tagging, and detects named entities such as item names or categories. The server may also apply intent classification and slot filling using a small neural network or a classical classifier trained on labeled dialogs. Based on these analyses, the server selects which parts of the stored context and which recommendation candidate information to include in the prompt sentence.

In a third embodiment, the server integrates speech recognition processing and emotion analysis processing into the system. The terminal captures audio signals from the user or the responder and sends the audio stream to the server in a digital format such as linear pulse-code modulation. The server applies an automatic speech recognition engine to convert the audio signals into text. The server may use an acoustic model and a language model implemented as neural networks to obtain recognition results. The server aligns the recognized text with timestamps and enriches the conversation history with these transcriptions.

The server applies emotion analysis to text or audio features. The server may use a classifier neural network trained to map text embeddings or acoustic feature vectors to emotion labels or continuous affective scores. The server encodes emotion information, such as likelihood of frustration or satisfaction, as numeric values stored in a conversation state structure. The server includes these emotion values in the prompt sentence provided to the generative AI model. As a result, the generative AI model can adjust tone or content, for example by generating more empathetic responses when the user appears to be frustrated.

In another embodiment, the server uses a modular architecture in which each functional component is implemented as a distinct software module. The server includes at least a data ingestion module, a feature store module, a recommendation inference module, a generative model interface module, a conversation analysis module, a prompt generation module, a response orchestration module, and a feedback logging module. Each module communicates via structured messages, for example records encoded as key-value pairs or hierarchical objects containing identifiers, timestamps, and payload fields.

The server uses the recommendation inference module to generate candidate recommendation target items. The server retrieves the current session context from a fast in-memory data store and retrieves long-term user features from the feature store. The server constructs an input tensor for the neural network model and executes inference on a CPU or GPU. The server receives predicted scores for multiple item candidates. The server selects a subset of items based on these scores and forms a candidate list. The server passes this candidate list to the prompt generation module, which embeds item identifiers, names, categories, and predicted scores into the prompt sentence.

The server uses the response orchestration module to merge outputs from the machine learning model and the generative AI model. The server receives from the generative AI model an answer text, explanation texts, ranking refinements, or response candidates. The server converts these outputs into a structured format that includes stable identifiers linking explanations to specific recommendation target items. The server sends this structured information to the terminal. The terminal displays, for example, a recommendation section showing a list of items with accompanying explanations such as “Recommended because you recently bought running shoes and are viewing outdoor training gear.”

The server improves computer technology by optimizing data representation and computation flow within the system. The server uses compact feature vectors and embedding representations to reduce the dimensionality of input data, thereby decreasing memory footprint and improving throughput of matrix operations on the CPU and GPU. The server avoids repeatedly transmitting large raw logs to the generative AI model by generating concise prompt sentences that contain distilled features and summaries. This reduces network bandwidth and latency, and prevents the generative AI model from performing redundant pre-processing on raw data.

The server further improves processing efficiency by combining batch-oriented updates and online inference in a coordinated manner. The server separates heavy training computation, which runs periodically on aggregated logs, from lightweight inference computation, which runs for each user interaction. The server uses a caching mechanism to reuse computed user feature vectors, avoiding recomputation for each request. This design results in lower response times and higher throughput, particularly when the number of users and items is large.

The server does not merely automate a manual procedure; instead, the server performs operations that are impractical for a human to perform in real time, such as maintaining high-dimensional embeddings, updating neural network weights based on streaming data, and constructing consistent prompt sentences with machine-optimized feature representations.

The server applies learning-based rules derived from data rather than fixed rule sets specified by human operators. The server uses non-conventional processing steps, such as combining ranking scores from a neural recommendation model with textual explanations synthesized by a generative AI model in a unified pipeline.

In another embodiment, the server uses a different machine learning architecture. The server may implement a sequence model such as a recurrent neural network, a gated recurrent unit network, or a transformer-based network to model the order of user interactions. The server encodes each event in the behavior history as an embedding and feeds the sequence into the network. The network outputs a context vector used to predict the next item to be selected.

The server trains this model using a sequence loss function, such as cross-entropy over the next event prediction. The server stores model parameters, including weights and biases of each layer and attention parameters, in a parameter store.

In yet another embodiment, the server uses an ensemble of models. The server may combine outputs from a collaborative filtering model, a content-based model, and a sequence model.

The server computes a weighted sum or other aggregation of the scores from each model. The server may feed this aggregated score set into the generative AI model as part of the prompt sentence, instructing the generative AI model to explain why each item is relevant based on multiple criteria. This multi-model approach improves recommendation accuracy and robustness against data sparsity.

The terminal cooperates with the server to present information and capture new behavior history. The terminal displays recommendation target items as graphical elements including images, names, and prices. The terminal receives user selection operations, such as clicks on recommended items or activation of a “more like this” control. The terminal sends these operations as structured events to the server. The server logs these events and uses them as behavior history in subsequent model training and inference. By capturing detailed event sequences at the terminal, the system builds training data that reflect actual user behavior patterns in fine granularity.

In a further embodiment, the terminal used by a responder presents operator support information. The terminal displays conversation text, emotion indicators, and response candidates generated by the generative AI model. The responder may select, edit, or discard response candidates. The terminal sends the responder's choice and editing actions to the server. The server can use these signals as labels indicating which responses were preferred or corrected, and can incorporate them into subsequent model updates or prompt generation logic adjustments. This feedback loop improves the quality of future response candidates and increases alignment between model outputs and operator practice.

The system achieves technical effects through the specific configuration and interaction of these components. Because the server maintains structured feature representations and performs targeted prompt generation, the generative AI model can produce more accurate and context-aware outputs while consuming fewer computational resources. Because the server integrates speech recognition and emotion analysis into the central decision pipeline, the server can adjust recommendations and responses in real time based on non-textual signals, which would not be feasible through manual or purely rule-based processing. Because the server continuously updates the machine learning model and prompt generation logic using new behavior history, the system maintains high recommendation accuracy and reduces the need for manual recalibration.

Alternative implementations are also possible. The server may deploy the machine learning models on dedicated inference hardware, such as specialized accelerator cards, and may apply quantization or model compression to reduce model size and accelerate inference. The server may store feature vectors in a key-value database optimized for low-latency retrieval.

The server may apply different prompt templates for different domains or user segments, and may dynamically select a template based on user attributes. The server may adjust the length and granularity of user behavior summaries included in the prompt sentence, balancing context richness and token budget for the generative AI model.

In all these embodiments, the server, the terminal, and the user cooperate in a unified architecture. The server executes concrete data processing operations, model training and inference operations, prompt sentence generation operations, and communication operations in a way that improves the performance and capabilities of the computer system itself. The system goes beyond a mere automation of human decision making and realizes a technical improvement in how interaction data is represented, processed, and utilized within a distributed computing environment.

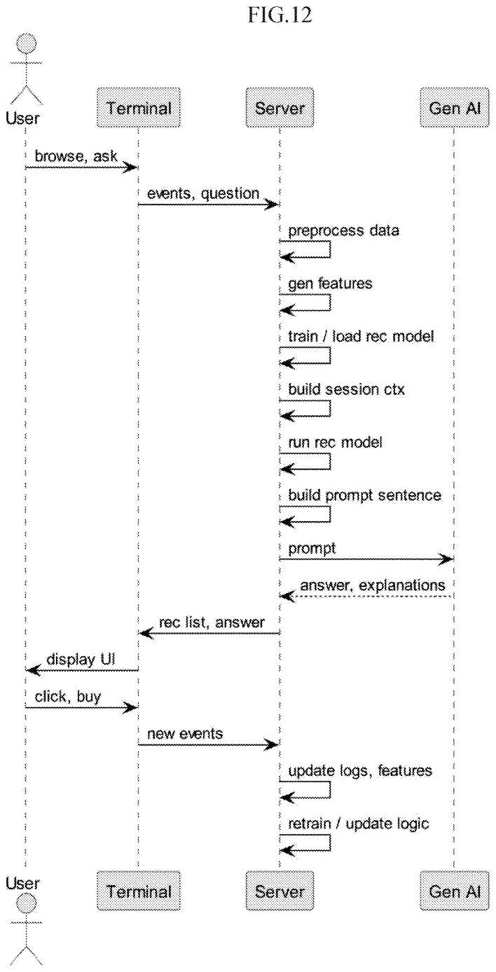

The following describes the processing flow using FIG. 12.

### Step 1

The server acquires raw data from multiple information sources.

The server receives, as input, log files and records including user behavior history (page views, clicks, searches, purchases), item attributes (category, price, stock), and system context (device type, network type) from storage systems and external services.

The server uses storage access libraries to read these data into memory and converts each record into a structured internal format with fields such as user_id, item_id, timestamp, event_type, and attribute values.

The server outputs a unified raw data set in a standardized schema that is ready for preprocessing.

### Step 2

The server preprocesses the unified raw data set to clean and normalize the data.

The server receives, as input, the unified raw data set from Step 1.

The server detects missing or inconsistent values in numeric fields (for example, price, quantity, duration) and replaces them using statistical values such as category-wise mean or median.

The server scales numeric fields using a normalization formula (for example, min-max scaling) and encodes categorical fields (such as user_id and item_id) as integer indices via lookup tables.

The server removes or flags corrupted records that do not satisfy format constraints.

The server outputs a cleaned and normalized data set in which each record is suitable for feature generation and machine learning processing.

### Step 3

The server generates feature vectors for users and items.

The server receives, as input, the cleaned and normalized data set from Step 2.

The server groups records by user_id and by item_id, and computes aggregate statistics, such as number of interactions per category, average price of purchased items, recency of last interaction, and conversion ratios.

The server encodes temporal patterns by calculating time intervals between events and counts within fixed time windows.

The server concatenates these aggregated values into numerical vectors representing user features and item features, and aligns them with corresponding identifiers.

The server outputs a set of feature vectors stored in a feature table or feature store, each vector associated with a user_id or item_id.

### Step 4

The server trains a recommendation machine learning model using the feature vectors.

The server receives, as input, the user feature vectors, item feature vectors, and historical interaction labels (for example, whether an item was clicked or purchased).

The server constructs training samples by pairing user features with item features and associating each pair with a label indicating interaction outcome.

The server feeds these samples into a neural network implemented by a machine learning framework and computes a loss value using a loss function such as binary cross-entropy or pairwise ranking loss.

The server updates the model parameters by performing gradient descent using an optimizer, repeatedly iterating over batches of training samples until convergence criteria are met.

The server outputs a trained recommendation model capable of predicting a relevance score for a given user-item pair.

### Step 5

The server prepares and maintains a prompt generation logic for a generative AI model.

The server receives, as input, configuration information describing prompt templates, such as fixed instructions, placeholders for user behavior summaries, recommendation candidates, and conversation context.

The server stores these templates in a configuration store and associates each template with identifiers indicating intended use cases (for example, recommendation explanation, question answering, operator assistance).

The server parses each template to identify placeholder names and defines mappings between placeholders and internal data sources, such as feature tables, conversation logs, and recommendation results.

The server outputs a prompt generation configuration that specifies how to construct a prompt sentence for the generative AI model in each use case.

### Step 6

The terminal captures user actions and sends interaction events to the server.

The user operates the terminal to browse pages, view item details, perform searches, and add items to a cart.

The terminal detects each action and constructs an event object including a user identifier, event type, item identifier (if applicable), timestamp, and context such as page type or query string.

The terminal sends these event objects as input to the server over a network using a communication protocol.

The terminal outputs, toward the server, a continuous stream of interaction events representing the current session.

### Step 7

The server logs interaction events and updates session context.

The server receives, as input, the interaction event stream from the terminal in Step 6.

The server writes each event to a persistent log store, tagging it with a unique event identifier and session identifier.

The server updates an in-memory session state structure for the corresponding user, appending the latest event and maintaining statistics such as current page, recently viewed items, and cumulative actions in the session.

The server outputs an updated session context that reflects the most recent behavior history for use in real-time processing.

### Step 8

The terminal transmits user questions or chat messages to the server.

The user enters a natural language question or message in a chat interface on the terminal.

The terminal captures the text, adds metadata such as user_id, session_id, and timestamp, and forms a message object.

The terminal sends this message object as input to the server via a request to a communication endpoint.

The terminal outputs a structured user query ready for natural language processing on the server.

### Step 9

The server performs natural language processing on the user question and conversation history.

The server receives, as input, the user question and the current conversation history, including prior messages in the same session.

The server tokenizes the text, performs syntactic analysis, and executes intent classification to determine the type of request (for example, product inquiry, order status, troubleshooting).

The server extracts entities such as item names, categories, and other key terms using entity recognition algorithms.

The server updates the conversation state with recognized intents and entities, and outputs a semantic representation of the user question and conversation context for use in subsequent modules.

### Step 10

The terminal captures voice input and sends audio data to the server when voice interaction is used.

The user speaks into a microphone of the terminal to ask a question or communicate with an operator.

The terminal samples the audio, encodes it in a digital format, segments it into packets, and attaches identifiers such as user_id and session_id.

The terminal sends the audio packets as input to the server through a communication channel.

The terminal outputs a sequence of audio data segments suitable for speech processing at the server.

### Step 11

The server converts audio data to text and analyzes emotion.

The server receives, as input, the audio data segments from the terminal in Step 10.

The server passes the audio through a speech recognition engine, which computes acoustic features, applies acoustic and language models, and outputs recognized text for each segment.

The server feeds the recognized text and, optionally, acoustic features into an emotion analysis module, which computes emotion labels or scores (for example, frustration, satisfaction, neutrality).

The server updates the conversation history with recognized text and stores emotion information associated with each utterance.

The server outputs an enriched conversation history containing transcribed text and emotion annotations.

### Step 12

The server retrieves relevant context data for recommendation and question answering.

The server receives, as input, the semantic representation of the user question, conversation context, session context, and user profile identifiers.

The server queries data stores to retrieve related item information, such as detailed attributes and availability, and relevant documents, such as FAQ entries or policy descriptions.

The server also obtains long-term user behavior summaries and previously computed feature vectors for the user.

The server compiles these data into a context bundle containing all information required to generate recommendations and answers.

The server outputs the context bundle as structured data for downstream processing.

### Step 13

The server runs the recommendation model to compute candidate recommendation target items.

The server receives, as input, the user feature vector, current session context, and a set of candidate items, each with its item feature vector.

The server forms input vectors by combining user features, session features, and item features for each candidate item.

The server feeds these input vectors into the trained neural network recommendation model and computes predicted scores for each candidate, using matrix multiplications and activation functions executed on CPU or GPU.

The server sorts the items by predicted score and selects a subset as candidate recommendation target items.

The server outputs a ranked candidate list containing item identifiers, scores, and associated feature information.

### Step 14

The server constructs a user behavior summary and conversation summary.

The server receives, as input, the long-term behavior history, the current session context, and the conversation history enriched with intent and emotion information.

The server applies summarization rules to extract key behaviors, such as frequently purchased categories, recent high-value purchases, and current interests inferred from page views and search terms.

The server also extracts key conversation turns, such as unresolved questions and expressed concerns, and compresses them into short textual statements.

The server assembles these elements into a concise user behavior summary and a conversation summary.

The server outputs these textual summaries for inclusion in a prompt sentence.

### Step 15

The server generates a prompt sentence for the generative AI model.

The server receives, as input, the prompt generation configuration, the user behavior summary, the conversation summary, the ranked candidate item list, and, when applicable, retrieved documents.

The server selects an appropriate prompt template based on the use case (for example, next-item recommendation explanation, direct question answering, operator assistance).

The server fills the placeholders in the template with actual data, such as inserting the behavior summary in a designated section, listing candidate items with brief descriptors, and embedding conversation excerpts.

The server forms a continuous text string that includes system instructions, contextual descriptions, and explicit tasks for the generative AI model.

The server outputs a completed prompt sentence ready to be sent to the generative AI model.

### Step 16

The server sends the prompt sentence to the generative AI model and obtains generated content.

The server receives, as input, the completed prompt sentence from Step 15 and parameters specifying output constraints such as maximum length and output style.

The server transmits the prompt sentence to the generative AI model through an application programming interface.

The generative AI model returns generated text, such as an answer text, item explanations, adjusted rankings, or response candidates.

The server parses the generated text, segments it into separate components (for example, one explanation per item, multiple response candidates), and associates each component with identifiers in the candidate list or conversation context.

The server outputs structured generative output containing answers, explanations, and other generated content.

### Step 17

The server merges recommendation outputs and generative outputs into response objects.

The server receives, as input, the ranked candidate item list from Step 13 and the structured generative output from Step 16.

The server creates response objects that combine each recommendation target item with its corresponding explanation, reasoning text, or adjusted score provided by the generative AI model.

The server also constructs a response message for the user or responder, selecting the most appropriate answer text or response candidate, and formatting it according to communication channel requirements.

The server adds display metadata, such as priority levels and presentation order, to each response object.

The server outputs a set of response objects representing recommendation information and response information to be sent to the terminal.

### Step 18

The server transmits response objects to the terminal.

The server receives, as input, the response objects from Step 17 and target terminal information such as user_id or responder_id.

The server converts the response objects into a communication format, for example a structured message including fields for item identifiers, titles, images, prices, and explanation texts, or a text message for the chat interface.

The server sends these messages to the terminal over a network connection.

The server logs the fact that particular recommendations and responses were delivered, associating this information with the session for later analysis.

The server outputs network responses that carry the recommendation target item list and answer text to the terminal.

### Step 19

The terminal renders recommendation information and response information for the user or responder.

The terminal receives, as input, the structured messages containing recommendation items, explanations, and answer texts from the server in Step 18.

The terminal parses the message, maps item identifiers to displayed components, and draws user interface elements such as item cards, text explanations, and buttons for interaction.

The terminal displays, on the screen, a recommendation section labeled, for example, “Recommended for you,” and shows the answer text in a chat window or support panel.

The terminal adapts the layout based on screen size and device type, and attaches event handlers so that user actions on displayed elements generate new events.

The terminal outputs a visual presentation through the display and prepares new event messages when the user interacts with the presented content.

### Step 20

The user interacts with recommendations and responses and performs selection or purchase operations.

The user views the displayed recommendation items and explanations on the terminal.

The user selects one of the recommended items, requests more details, or chooses one of the provided response candidates in the operator scenario.

The user may add selected items to a cart and proceed through a purchase workflow on the terminal's interface.

The user's actions cause the terminal to generate new interaction events, such as item_selection, add_to_cart, or complete_purchase, and send them to the server.

The user thus produces new behavior history that becomes input for future data processing and model updates.

### Step 21

The server logs new behavior history and updates training data.

The server receives, as input, the new interaction events and purchase records generated in Step 20.

The server appends these records to persistent log tables and updates aggregated statistics in the feature store, recalculating user and item features where necessary.

The server incorporates the new data into the training data set used for the recommendation model, applying any required preprocessing and feature generation operations.

The server schedules or triggers a retraining or fine-tuning process for the recommendation model and, if applicable, adjusts prompt generation logic based on observed outcomes.

The server outputs updated training data and metadata, which will be used in subsequent training cycles.

### Step 22

The server retrains or updates models and prompt generation logic based on accumulated behavior history.

The server receives, as input, the expanded training data set that includes newly logged behavior history.

The server reruns the training procedure for the recommendation model, computing loss values and updating model weights to reflect new interaction patterns.

The server analyzes which prompt templates and prompt contents produced effective outcomes, based on success metrics such as click-through rate or resolution rate, and adjusts template parameters or placeholder selection rules.

The server deploys updated model parameters and prompt generation rules to the runtime environment, replacing prior versions while maintaining consistency.

The server outputs improved models and updated prompt generation configurations that provide higher accuracy, reduced error rates, and more context-aware responses in subsequent interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional information response systems that utilize machine learning or rule-based engines often suffer from several technical limitations at the computing system level.

First, in many architectures, user inquiries in natural language are passed directly to a language model or a fixed-response engine without adequate normalization, intent extraction, or context-aware prompt construction. This results in inefficient use of computational resources, because the language model must internally perform redundant parsing and disambiguation for noisy, inconsistently formatted input, thereby increasing processing latency and variability of response quality.

Second, existing systems typically do not leverage structured and unstructured domain information sources in a unified, machine-learned training information set that is explicitly used to refine prompt generation and response post-processing. As a result, the system often fails to adapt to accumulated interaction records, product-related information, or navigation-related information, leading to unnecessary repetition of computation, lack of knowledge reuse, and degraded accuracy of responses over time.

Third, many implementations treat the generative AI model as a black-box component and do not control, at the processor level, the structure of prompt sentences and the conditions of input to the generative AI model in a systematic manner. Without this control, response generation can consume excessive processing cycles on external or internal computing resources, produce unstable output formats, and impose additional burdens on downstream modules and terminal devices, thereby degrading system throughput and responsiveness.

Fourth, when response texts generated by a generative AI model are provided to terminals without dedicated post-processing in the server, terminal-side applications are required to implement complex formatting, normalization, and filtering logic. This leads to fragmented processing pipelines, duplicated computation across multiple terminals, inefficient use of network and processor resources, and difficulty in maintaining consistent response quality across different client environments.

Accordingly, there is a need for a computer-implemented technique that improves the internal operation of an information processing system by: (i) systematically normalizing and analyzing user inquiries prior to passing them to a generative AI model; (ii) constructing and updating a training information set from multiple information sources using statistical learning methods; (iii) dynamically generating prompt sentences that encode extracted intent and related information; and (iv) performing centralized, server-side post-processing of generated responses. By addressing these issues at the processor and system architecture level, the invention aims to improve processing efficiency, reduce end-to-end latency, stabilize response formats, and enhance the overall technical performance of the computer system itself, rather than merely automating human support tasks.

The specific processing by the specific processing unit 290 of the data processing device 12 in Example 2 is realized by the following means.

The present invention provides a server comprising a processor and a memory storing instructions that, when executed by the processor, cause the processor to collect structured and unstructured information from a plurality of information sources and construct a training information set using a statistical learning method; to receive, via a terminal device, a natural language inquiry from a user and normalize the natural language inquiry by performing character string processing and natural language analysis to generate analyzed text data; to extract, from the analyzed text data, an inquiry intent and related information and dynamically generate a prompt sentence including the intent and the related information based on template information, the prompt sentence being configured as input to a generative AI model; to transmit the prompt sentence to the generative AI model disposed externally or internally via a communication mechanism and acquire, from the generative AI model, a response text generated based on the prompt sentence; to perform server-side post-processing on the response text, the server-side post-processing including character string formatting, notation unification, and grammar checking, to generate a final response text that is presentable to the terminal device; and to transmit the final response text to the terminal device via a communication path so that the terminal device presents the final response text to the user, and further cause the processor to store domain-related information including product-related information, information-providing site-related information, communication guidance-related information, and user interaction records in an information storage device, analyze the stored information using the statistical learning method to update the training information set, and improve contents of the prompt sentence and the response text based on the updated training information set, and to control a structure of the prompt sentence and input conditions to the generative AI model so as to improve response speed of inquiry processing, improve information-providing quality, and reduce workload on support personnel. This enables technical improvement of the computing system by reducing redundant processing within the generative AI model, lowering end-to-end response latency, stabilizing output formats for efficient rendering on terminal devices, and adaptively refining prompt construction and response post-processing based on learned information, thereby enhancing throughput, resource utilization, and reliability of the server-side information response pipeline.

The term “system” refers to a combination of one or more computing devices, communication paths, and storage resources that cooperate to execute the claimed processing operations.

The term “processor” refers to a hardware execution unit, such as a central processing unit or an equivalent processing circuit, configured to execute instructions to perform data processing operations described in the claims.

The term “memory” refers to a hardware storage resource, such as volatile memory or non-volatile memory, configured to store instructions and data used by the processor.

The term “terminal device” refers to an end-user computing device, such as a client terminal, mobile device, or similar apparatus, configured to transmit user inquiries to the server and present response information to the user.

The term “user” refers to a human operator or an entity that initiates an inquiry via the terminal device and receives response information generated by the system.

The term “information source” refers to any origin of data, including structured data stores and unstructured content repositories, from which information is obtained for constructing or updating a training information set.

The term “structured information” refers to data represented in a predefined schema or format, such as records, tables, or key-value pairs, that can be directly processed using conventional data management techniques.

The term “unstructured information” refers to data not constrained to a predefined schema, including free-form text, documents, logs, or similar content requiring natural language or pattern analysis for processing.

The term “training information set” refers to a collection of data derived from one or more information sources and processed by a statistical learning method, the collection being used to support generation, refinement, or evaluation of prompts and responses.

The term “statistical learning method” refers to a computational technique, such as a machine learning or data-driven analysis algorithm, that uses statistical properties of data to infer patterns or models.

The term “natural language inquiry” refers to a sequence of words or symbols expressed in a human language and provided by the user to request information or support.

The term “character string processing” refers to operations performed on text data, including trimming, normalization, removal of unnecessary characters, and formatting of character sequences.

The term “natural language analysis” refers to processing that interprets or structures natural language text, including tokenization, syntactic analysis, semantic analysis, or similar techniques.

The term “analyzed text data” refers to text obtained after applying character string processing and natural language analysis to a natural language inquiry.

The term “inquiry intent” refers to a representation of the purpose or objective underlying a user's natural language inquiry as determined by analysis of the inquiry.

The term “related information” refers to contextual data associated with the inquiry intent, including entities, attributes, conditions, or parameters extracted from the analyzed text data or other data sources.

The term “template information” refers to predefined structures or patterns of text that specify how a prompt sentence is to be formed from inquiry intent and related information.

The term “prompt sentence” refers to a text sequence generated by the processor that encodes instructions, context, and user inquiry information for input to a generative AI model.

The term “generative AI model” refers to a computational model employing machine learning techniques that produces output text based on an input prompt sentence.

The term “communication mechanism” refers to hardware and software components, such as network interfaces and communication protocols, that enable transmission of data between the server and external or internal components, including a generative AI model.

The term “response text” refers to text data generated by the generative AI model in response to a prompt sentence and acquired by the processor.

The term “post-processing” refers to processing applied to response text after it is generated, including character string formatting, notation unification, grammar checking, filtering, or other transformations to produce a final response.

The term “final response text” refers to response text that has been subjected to post-processing and is in a form suitable for presentation to the user via the terminal device.

The term “communication path” refers to a logical or physical route over which data is transmitted between the server and the terminal device.

The term “information storage device” refers to a hardware storage component, such as a database system or storage medium, configured to store domain-related information and interaction records.

The term “product-related information” refers to data describing characteristics, specifications, or attributes of goods or services offered or managed by an organization.

The term “information-providing site-related information” refers to data associated with sites or platforms that supply information to users, including structure, navigation, or content metadata of such sites.

The term “communication guidance-related information” refers to data defining procedures, rules, or guidelines for communication or navigation in a support or information-providing context.

The term “user interaction record” refers to stored data representing past exchanges, inquiries, responses, or actions between the user and the system.

The term “input conditions” refers to configuration parameters or constraints under which data is provided to the generative AI model, including format, length, control settings, or other model input parameters.

The term “support personnel” refers to human operators or staff responsible for assisting users or managing user interactions, whose workload may be influenced by the system's operation.

In one embodiment, a server includes a processor, a main memory, a non-volatile storage device, and a network interface, and cooperates with one or more terminals operated by users. The server executes an operating system such as a general-purpose server operating system, and an application layer implemented, for example, in a programming language environment such as a Python runtime with a web framework or a JavaScript runtime with a web framework. The server and the terminal communicate via a packet-switched network using a transport protocol and an application protocol.

The server stores, in the non-volatile storage device, multiple software modules including: a data collection module, a training information set construction module, a natural language analysis module, a prompt sentence generation module, a generative AI model communication module, a response post-processing module, a domain information management module, and a control module that orchestrates these components. The server stores, in a data store such as a relational database or a document-oriented database, domain-related information including product-related information, information-providing site-related information, communication guidance-related information, and user interaction records.

The terminal includes a processor, a memory, a display device, an input device such as a keyboard or touch panel, and a communication interface. The terminal executes a client application, for example a web browser or a native application, that presents a graphical user interface. The terminal sends text data representing a user's natural language inquiry to the server and displays text data representing a response from the server.

The user operates the terminal to input an inquiry sentence in natural language. The user confirms the inquiry by a designated input operation. The terminal transmits the input inquiry sentence to the server as text data. The terminal, in some embodiments, additionally transmits metadata such as a user identifier, a language preference, or a device type. The user then waits for a response and subsequently views the response on the display.

The server uses the data collection module to obtain structured and unstructured information from multiple information sources. The server, for example, retrieves product-related information from a product database, retrieves information-providing site-related information by periodically crawling internal or external web resources, retrieves communication guidance-related information from configuration repositories, and retrieves user interaction records from a log database. The server represents the collected data in one or more internal data structures, such as key-value maps or document objects.

The server uses the training information set construction module to construct a training information set from the collected data by applying statistical learning methods. In one embodiment, the server applies a supervised learning algorithm such as gradient-boosted decision trees or a neural network classifier to label past user inquiries with intent categories and associated response patterns. The server stores feature vectors derived from tokenized text, term frequency-inverse document frequency values, or embedded representations produced by a pre-trained language encoder. The server periodically updates the training information set as new user interaction records and domain information are collected, thereby reflecting temporal changes and new content.

The server uses the natural language analysis module to normalize and analyze user inquiries.

The server removes unnecessary spaces, control characters, and unsupported symbols using string manipulation functions. The server applies a tokenizer and a sentence segmenter, for example from a natural language processing library, to split the input into tokens and sentences. The server then applies a syntactic parser, such as a dependency parser or constituency parser, to derive a syntactic structure. The server may also use a named entity recognition model to identify entities such as product names, geographic locations, dates, and quantities. The server encodes the resulting analysis in a structured representation, such as an internal object containing fields for normalized text, token sequence, part-of-speech tags, and recognized entities.

The server uses the training information set and the natural language analysis results to determine an inquiry intent. In one embodiment, the server applies a multi-class classifier implemented as a feedforward neural network that takes as input a concatenation of token embeddings, entity indicators, and statistical features. The server computes an output probability distribution over intent categories such as weather information, product specification information, troubleshooting guidance, or account-related information. The server selects the intent category with the highest probability above a threshold and stores this as the inquiry intent, along with the associated confidence value.

The server uses the prompt sentence generation module to dynamically generate a prompt sentence for a generative AI model. The server prepares template information that specifies the structure of the prompt sentence. For example, the server may store a template such as:

### System Instruction:

You are an assistant that answers user questions accurately.

### Task:

Based on the user's question and the extracted intent, generate a detailed and accurate answer in English.
Intent: {intent}
User's question: ‘{question}’

The server replaces placeholders in the template with actual values derived from the analysis, such as intent and normalized question text. For a weather-related question, the server generates a concrete prompt sentence such as:

### System Instruction:

You are an assistant that answers user questions accurately.

### Task:

Based on the user's question and the extracted intent, generate a detailed and accurate answer in English.
Intent: weather info
User's question: ‘Please tell me today's weather.’

For a product specification question, the server may prepare a different template such as: Based on the user's question and the extracted product name, please describe the main specifications of the product in clear English, including display, CPU, memory, storage, camera, and battery.
Intent: product_spec_info
Product name: {product_name}
User's question: ‘{question}’

The server then generates a prompt sentence such as:

Based on the user's question and the extracted product name, please describe the main specifications of the product in clear English, including display, CPU, memory, storage, camera, and battery.
Intent: product_spec_info
Product name: Model X smartphone
User's question: ‘What are the specifications of Model X smartphone?’

In some embodiments, the server augments the prompt sentence with external data retrieved in real time. For example, when the intent is weather_info, the server calls an external weather information service via the network interface, receives current weather data, and appends the data in a human-readable form to the prompt sentence, together with explicit instructions to use that data. This augmentation reduces the need for the generative AI model to infer or hallucinate external facts and thereby improves accuracy and computational efficiency.

The server uses the generative AI model communication module to send the generated prompt sentence to a generative AI model. The generative AI model may be deployed on the same physical server, on a dedicated hardware accelerator device, or on an external service accessible via the network. In one embodiment, the generative AI model is implemented as a transformer-based neural network having multiple self-attention layers, feedforward layers, and layer normalization components. The model uses token embeddings and positional encodings to convert input text into internal numeric representations and generates output tokens by autoregressive decoding. The server converts the prompt sentence into tokens using a tokenizer consistent with the generative AI model, sets parameters such as maximum output length, sampling temperature, and top-k or top-p sampling thresholds, and transmits the tokenized prompt sentence and parameters to the generative AI model.

The server, when the generative AI model resides externally, uses the network interface to send an encoded representation of the prompt sentence to a remote computing system. The remote computing system executes the generative AI model on hardware accelerators such as graphics processing units or tensor processing units. The model performs matrix multiplications, non-linear activations, and attention computations to produce a sequence of output token probabilities. The remote system decodes these probabilities into discrete tokens and returns a response text to the server. The server then decodes the response into a text string in the memory.

The server uses the response post-processing module to process the response text. The server removes leading or trailing whitespace and unneeded prefix phrases. The server applies a grammar and style checker implemented as rule-based logic or as a smaller neural model specialized for grammatical correction. The server unifies notation, for example by converting units to a consistent format or standardizing date expressions. The server may partition long responses into paragraphs or bullet-like segments according to predetermined length thresholds, thereby optimizing display on the terminal. In some embodiments, the server executes a content filter that uses a classifier trained to detect inappropriate content. If disallowed content is detected, the server either regenerates the response using a fallback prompt sentence or masks the offending segments.

The server then delivers the final response text to the terminal. Because the server has normalized the inquiry, generated a structured prompt sentence, controlled the generative AI model parameters, and post-processed the response, the final response text has a predictable format and is suitable for direct display. This reduces the complexity of the terminal-side application and ensures consistent behavior across heterogeneous terminals.

The server, through the domain information management module, continually updates the training information set. The server writes new user interaction records into the data store, capturing for each inquiry the normalized text, detected intent, generated prompt sentence, generated response, and optionally user feedback or subsequent correction. The server periodically re-trains or fine-tunes the intent classifier and related statistical models using supervised learning. For example, the server may minimize a cross-entropy loss between predicted intent distributions and ground-truth labels, using stochastic gradient descent or a variant such as Adam optimization. The server updates model weights stored in memory and, after validation, activates the new model versions in the natural language analysis module.

In some embodiments, the server uses a reinforcement or bandit-style approach to adjust prompt sentence structures. The server measures technical metrics such as average response length, token consumption, and processing latency, and correlates these with different prompt templates and model parameter settings. The server then selects or adapts templates that reduce latency and token usage without sacrificing accuracy. This constitutes a feedback-driven control of the computing pipeline, beyond mere automation of human decision-making.

The server thereby improves computer technology in several ways. By normalizing inquiries and extracting intents before invoking the generative AI model, the server reduces the entropy of input sequences, which allows the model to converge to appropriate responses with fewer internal decoding steps, reducing end-to-end latency and resource consumption.

By generating prompt sentences that explicitly embed structured intent and related information, the server constrains the search space of the generative AI model and reduces spurious or irrelevant outputs, improving accuracy and stability. By maintaining and updating a training information set derived from multiple domain information sources and interaction records, the server adapts its preprocessing and prompting behavior to observed data distributions, which leads to improved performance on the specific domain with fewer model calls and less redundant computation. By centralizing response post-processing on the server, the system eliminates the need for each terminal to implement heavy natural language handling, reducing duplicated processing across devices and lowering aggregate network bandwidth due to more compact, pre-formatted responses.

In addition, the server utilizes processing rules and model control mechanisms that are distinct from manual human work. For instance, the server uses explicit numeric thresholds for intent confidence, performs beam search or constrained decoding at the generative AI model interface, enforces maximum token budgets based on network and hardware capacity, and uses analytically defined scoring functions to evaluate candidate prompt template variants. These non-conventional, machine-specific rules are not practical for human operators to apply manually at scale, and they directly modify the pattern of computation in memory and processing circuitry.

In alternative embodiments, the server may employ different generative AI models or architectures, such as encoder-decoder transformers or recurrent neural networks with attention, while maintaining the same overall pipeline of intent extraction, structured prompt sentence generation, controlled model invocation, and server-side post-processing. The server may also vary the granularity of intents, for example by introducing hierarchical categories, and adjust the template information accordingly. The server may use different storage technologies, such as in-memory data grids, and different deployment configurations, such as a distributed cluster of servers executing the described modules in a scalable manner. In each variation, the server applies the same fundamental concept: explicit control over data structures, processing order, and model input-output behavior to improve hardware and network utilization and to enhance the determinism and efficiency of the overall information response system.

The terminal may also have alternative configurations. In one variant, the terminal executes a thin client that simply relays text and displays responses; in another, the terminal may perform limited preprocessing, such as local spell-checking, while the server remains responsible for core normalization, intent extraction, prompt sentence generation, and generative AI model interaction. In all cases, the terminal does not need to maintain a copy of the generative AI model, which avoids excessive memory usage and computation on resource-constrained devices and centralizes sophisticated processing on the server.

Through these embodiments and variants, the system implements specific, structured data flows and algorithmic procedures that transform input text data and internal state across multiple stages, using defined modules, mathematical models, and control logic. As a result, the system achieves technical effects including faster response time, higher accuracy, reduced variability, and more efficient use of computational and communication resources, thereby improving the operation of the computer-based information processing system itself.

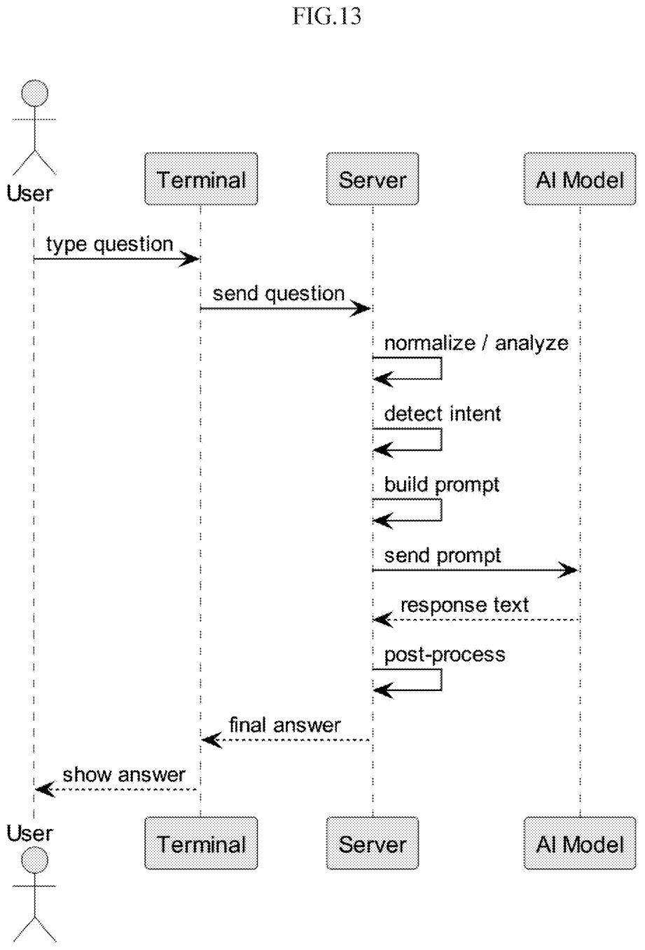

The following describes the processing flow using FIG. 13.

### Step 1

User operates the terminal to input a natural language inquiry.

User types a text sentence, such as “Please tell me today's weather.”, into an input field displayed on the terminal's screen and confirms the input by pressing a send button or an enter key. The input is a raw character string representing the inquiry, and there is no particular formatting imposed by the system at this stage. The output of this step is the raw inquiry text held in a user interface component of the terminal.

### Step 2

Terminal transmits the raw inquiry text to the server.

Terminal takes the raw inquiry text from the input field and encapsulates it into a request message together with optional metadata, such as a user identifier, a language code, or a device type. Terminal then uses its communication interface to send the request to the server via a network protocol. The input of this step is the raw inquiry text stored in the terminal, and the output is a network message containing the raw inquiry text that reaches the server's network interface.

### Step 3

Server receives the raw inquiry text and performs basic text normalization.

Server reads the incoming network message using a communication stack, extracts the raw inquiry text, and stores it in memory. Server then applies character string processing operations, including trimming leading and trailing spaces, converting multiple consecutive spaces to a single space, and removing control characters or unsupported symbols by using pattern matching routines. The input of this step is the raw inquiry text from the terminal, and the output is a normalized text string that is syntactically cleaner and ready for further natural language analysis.

### Step 4

Server performs natural language analysis and constructs an analyzed text representation.

Server passes the normalized text string to a natural language analysis module, which executes tokenization, sentence segmentation, and part-of-speech tagging. Server may also execute syntactic parsing to build a dependency graph and perform named entity recognition to detect entities such as product names, locations, dates, or quantities. As data operations, the server converts the normalized text into a sequence of tokens, computes linguistic features for each token, and organizes these features into structured data fields. The input of this step is the normalized text string, and the output is an analyzed text representation containing the token list, linguistic annotations, and recognized entities.

### Step 5

Server determines the inquiry intent and extracts related information.

Server applies an intent classification algorithm to the analyzed text representation. For example, the server feeds a vector representation of the tokens, together with entity indicators and other features, into a trained classifier. The classifier computes scores for each possible intent, such as weather information, product specification, or troubleshooting guidance.

Server selects the highest-scoring intent above a threshold and identifies related information, including specific entities and context parameters. The input of this step is the analyzed text representation, and the output is an intent object that includes the selected intent label, a confidence score, and a set of related information items.

### Step 6

Server constructs a structured internal data object for prompt generation.

Server combines the normalized text, the analyzed text representation, and the intent object into a unified internal data object. Server explicitly associates fields for original inquiry text, normalized text, intent label, recognized entities, and any additional context such as language preference. In terms of data transformation, the server aggregates previously separate structures into a single composite object that can be used by the prompt sentence generation module without further lookup. The input of this step is the intent object and analyzed text representation, and the output is a consolidated inquiry context object.

### Step 7

Server generates a prompt sentence based on template information and inquiry context.

Server selects a prompt template corresponding to the determined intent. For example, for a weather_info intent, the server selects a template that instructs the generative AI model to output the latest weather information. Server then replaces placeholders in the template with concrete values from the inquiry context object. As an example, server generates a prompt sentence such as:

### System Instruction:

You are an assistant that answers user questions accurately.

### Task:

Based on the user's question and the extracted intent, generate a detailed and accurate answer in English.
Intent: weather_info
User's question: ‘Please tell me today's weather.’

The input of this step is the inquiry context object and the stored template information, and the output is a fully formed prompt sentence represented as a text string.

### Step 8

Server optionally augments the prompt sentence with domain or real-time data.

Server examines the intent and determines whether external data retrieval is beneficial. For a weather info intent, the server uses its communication interface to query an external weather information service and receives structured weather data such as temperature, conditions, and forecast. Server converts this structured data into a concise textual summary and appends it to the prompt sentence together with explicit instructions, for example: “Here is the latest weather data: condition: sunny, high: 25° C., low: 16° C. Please use this data when generating the answer.” The input of this step is the prompt sentence and, if applicable, data retrieved from external information sources, and the output is an augmented prompt sentence that embeds up-to-date domain data.

### Step 9

Server transmits the prompt sentence to the generative AI model and configures generation parameters.

Server prepares a model input structure that contains the prompt sentence and generation parameters such as maximum token count, sampling temperature, and decoding strategy. If the generative AI model resides on an external system, the server encodes this structure into a request and sends it via the network; if the model resides locally, the server passes the prompt sentence to a model inference interface. The input of this step is the augmented prompt sentence and default or adaptive generation parameters, and the output is a formatted model input ready for processing by the generative AI model.

### Step 10

Server (or an associated model host) executes the generative AI model to generate a response text.

Server (or the remote model host) tokenizes the prompt sentence, maps tokens to numeric embeddings, and processes them through the layers of a generative AI model, such as a transformer network with self-attention and feedforward blocks. The model iteratively computes attention scores, updates hidden states, and predicts the next token distribution until a termination condition is met. The system then converts the generated token sequence back into a text string. The input of this step is the tokenized prompt sentence and model parameters, and the output is a raw response text produced by the generative AI model.

### Step 11

Server receives the raw response text and performs response post-processing.

Server collects the raw response text from the generative AI model interface and applies string-level cleanup, such as removing leading newlines or trailing incomplete sentences.

Server optionally runs the response through a grammar and style checking module, which detects and corrects grammatical inconsistencies or formatting anomalies. Server also unifies notation, for example ensuring consistent units or date formats. If a content filter is enabled, the server evaluates the response against safety or appropriateness rules and modifies or rejects the response if necessary. The input of this step is the raw response text from the generative AI model, and the output is a final response text that is grammatically consistent and formatted for display.

### Step 12

Server packages and transmits the final response text to the terminal.

Server embeds the final response text into a response message structure and uses its communication stack to send the message to the terminal over the network. The server may also attach metadata, such as an intent identifier or a timestamp, if useful for logging or display. The input of this step is the final response text produced by post-processing, and the output is a network message carrying the final response text to the terminal.

### Step 13

Terminal receives the final response text and presents it to the user.

Terminal reads the incoming message from the server via its communication interface, extracts the final response text, and updates its user interface. Terminal renders the text in a display component, such as a chat bubble or text area, using layout and styling rules suitable for the device. The input of this step is the network message containing the final response text, and the output is a visual representation of the response text on the terminal's display that the user can read.

### Step 14

User views the response and optionally initiates a follow-up inquiry.

User reads the displayed final response text and determines whether additional information is needed. If the user wishes to continue, the user inputs a new inquiry, such as “How about tomorrow's weather?”, into the terminal. The input of this step is the displayed final response text, and the output is either a termination of the interaction or a new raw inquiry text that serves as input to Step 1 in a subsequent processing cycle.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional customer support and dialog systems typically treat question understanding, knowledge retrieval, answer generation, and emotion handling as separate and weakly coupled functions. In many architectures, a server first performs simple keyword matching on a user question, then forwards the result to a generic response engine, while any emotion analysis is performed in parallel and only loosely influences operator behavior. Such fragmented processing leads to several technical problems in the operation of computer systems.

First, a server that performs only shallow text matching and static rule-based response selection often produces low-relevance answers, particularly when questions are ambiguous or when knowledge bases are large and heterogeneous. This causes unnecessary retries, additional database queries, and repeated network transactions between terminals and servers, thereby increasing processor load, memory access overhead, and network bandwidth consumption.

Second, existing systems generally log user questions and responses only as unstructured text without integrating this information into the training data for the underlying models in a systematic manner. As a result, the server cannot efficiently reuse past dialog interactions to improve the performance of its language models and retrieval logic, leading to stagnation of model accuracy and inefficient utilization of stored data in memory and external storage.

Third, emotion analysis in conventional systems is often implemented as an auxiliary, post-hoc layer. A server may detect emotion from user voice or text but does not tightly integrate the emotion state into the construction of prompts provided to a generative AI model, nor into the selection and filtering of answer expressions. This separation prevents the processor from optimizing generation parameters and output selection in real time based on emotion, and thus does not minimize the number of corrective interactions or follow-up questions required to satisfy the user.

Fourth, dialog operator support in many systems relies on static decision trees or pre-written scripts displayed on operator terminals. Because these scripts do not reflect real-time context retrieval and emotion-conditioned generative outputs, the server must repeatedly access disparate application modules to provide guidance, resulting in increased inter-process communication, redundant computation, and delays in rendering information on operator and user terminals.

Accordingly, there is a need for a computer-implemented system that improves the internal processing of a server by: (i) tightly integrating natural language preprocessing, context retrieval, and prompt sentence construction; (ii) coupling generative AI model inference with emotion-aware adjustment of prompts and responses; and (iii) systematically recording and reusing dialog history as structured training data. Such a system should reduce unnecessary computation and memory access, increase the relevance and stability of generated responses, and improve the efficiency of dialog handling on both operator terminals and user terminals, thereby achieving a concrete improvement in the operation of computer technology itself.

The specific processing by the specific processing unit 290 of the data processing device 12 in Application Example 2 is realized by the following means.

The present invention provides a server comprising a processor configured to collect information from a plurality of information sources and construct a training data set by statistical learning processing, perform natural language analysis processing on a question sentence transmitted from a user terminal to preprocess the question sentence and to extract intent information and element information, execute search processing based on the intent information and the element information to acquire context information related to the question sentence from an information set stored in a storage device and to integrate the context information into a predetermined length, generate, in a predetermined format, a prompt sentence including the question sentence and the context information and further including label information and an instruction text, input the prompt sentence to a generative AI model, generate, by probabilistic inference processing of the generative AI model, a response sentence corresponding to the prompt sentence and perform length limitation processing and content filtering processing on the response sentence, analyze voice information, character information, and image information of a user by emotion analysis processing to specify an emotional state and adjust contents of the prompt sentence input to the generative AI model or an expression of the response sentence in accordance with the emotional state, cause a dialogue operator terminal to display supplementary information and an answer candidate on the basis of the response sentence and the emotional state and to transmit and display the response sentence to the user terminal, and record the question sentence, the context information, the prompt sentence, and the response sentence as history information and reuse the history information in the statistical learning processing. This enables the server to internally optimize its computation by unifying context retrieval and prompt construction, to adapt generative AI model behavior in real time to emotion-aware prompt sentences, to reduce redundant dialog turns and processing overhead through higher-quality initial responses, and to continuously improve model performance by feeding structured dialog history back into the statistical learning process, thereby achieving a concrete improvement in the functioning and efficiency of the underlying computer system.

The term “processor” refers to a hardware or virtual processing unit, including one or more central processing units or accelerator units, that executes instructions to perform the functions described in the system.

The term “information source” refers to any logical or physical origin of data, including structured databases, unstructured document repositories, log storage devices, and external service interfaces, from which the system obtains information for analysis and learning.

The term “training data set” refers to a collection of data samples, including input features and optionally target outputs, that is prepared and structured for use by a learning algorithm to determine model parameters.

The term “statistical learning processing” refers to computational procedures, including machine learning and pattern recognition techniques, that adjust parameters of a model based on statistical properties of the training data set.

The term “user terminal” refers to an electronic device operated by a user, such as a portable device, a stationary computing device, or a display apparatus, that transmits question sentences and receives response sentences through a communication network.

The term “question sentence” refers to a natural language text string or equivalent encoded content representing an inquiry from the user regarding information, service, or operation.

The term “natural language analysis processing” refers to a sequence of computational operations performed on a question sentence, including at least one of tokenization, part-of-speech tagging, syntactic parsing, semantic analysis, or named entity recognition, to derive structured information.

The term “intent information” refers to a representation of a communicative goal of the question sentence, such as a category of request or desired action, identified by the natural language analysis processing.

The term “element information” refers to one or more parameters, entities, or slots, such as identifiers, attributes, or values, extracted from the question sentence and used to refine search and response generation.

The term “search processing” refers to computational operations that, based on intent information and element information, retrieve candidate data items from an information set stored in a storage device.

The term “context information” refers to information items obtained by search processing that are related to the question sentence and that are used as supporting data for response generation.

The term “storage device” refers to any non-transitory computer-readable medium, including primary storage and secondary storage, that retains the information set, structured information, history information, and model-related data.

The term “prompt sentence” refers to a text sequence or equivalent encoded representation provided as input to a generative AI model, the text sequence including at least the question sentence and the context information, and optionally labels and instructions defining a generation task.

The term “label information” refers to textual or symbolic markers included in the prompt sentence that specify roles, sections, or types of content, such as identifiers for question, context, or answer.

The term “instruction text” refers to a portion of the prompt sentence that explicitly directs the generative AI model how to formulate a response, including constraints on style, length, or content.

The term “generative AI model” refers to a trained computational model that receives a prompt sentence and outputs a generated text sequence by performing probabilistic inference over learned parameters.

The term “probabilistic inference processing” refers to internal computations of the generative AI model in which probability distributions over possible output tokens or sequences are calculated and sampled or selected to produce a response sentence.

The term “response sentence” refers to a natural language text string or equivalent encoded content generated by the generative AI model in reply to the question sentence based on the prompt sentence.

The term “length limitation processing” refers to operations that restrict the response sentence to a maximum size, by truncating, summarizing, or otherwise reducing the number of characters, tokens, or units.

The term “content filtering processing” refers to operations that examine the response sentence and remove, modify, or replace parts of the content according to predetermined rules, policies, or safety criteria.

The term “voice information” refers to digital representations of acoustic signals associated with user speech, including waveform samples, features, or encoded audio data.

The term “character information” refers to textual data, including sequences of characters, symbols, or codes, representing user input or system output in natural language.

The term “image information” refers to digital visual data, including still images or image frames, that depict at least part of a user, such as a face or gesture, or related visual context.

The term “emotion analysis processing” refers to computational operations that estimate an emotional state of the user from at least one of voice information, character information, or image information.

The term “emotional state” refers to a classification or parameterization of a user's inferred emotion, such as satisfaction, dissatisfaction, anger, calmness, or other affective conditions.

The term “dialogue operator terminal” refers to an electronic device operated by a human dialogue operator, the device being configured to display supplementary information and answer candidates and to support interaction with the user.

The term “supplementary information” refers to additional data presented to the dialogue operator, derived from context information or other sources, that supplements the response sentence for use in handling the dialogue.

The term “answer candidate” refers to a proposed response text or variant thereof presented to the dialogue operator for review, modification, or use in communication with the user.

The term “history information” refers to stored records of past interactions, including question sentences, context information, prompt sentences, and response sentences, associated with metadata for subsequent analysis or learning.

The term “structured information” refers to data organized according to a defined schema or format, such as tables, records, fields, or key-value pairs, that enables efficient storage, retrieval, and processing.

The term “information relating to a product” refers to structured or unstructured data describing items or services offered, including attributes, specifications, pricing, and policies.

The term “information relating to a service providing environment” refers to data describing conditions or parameters under which a service is provided, including time schedules, location constraints, and availability conditions.

The term “information relating to a communication route” refers to data describing network paths, communication channels, or routing conditions used for interactions between the user terminal, the dialogue operator terminal, and the server.

The term “information relating to a dialogue history” refers to records of prior exchanges between the user and the system or the dialogue operator, including messages, timestamps, and associated states.

The term “dialogue handling” refers to processing that manages the exchange of information between the user and the system or the dialogue operator, including selection, presentation, and timing of responses.

The term “user satisfaction” refers to a qualitative or quantitative measure indicating how effectively the responses and system behavior meet the user's expectations or needs.

The term “workload of the dialogue operator” refers to a measure of computational and cognitive effort required by the dialogue operator to conduct interactions, including the volume of manual actions and time spent per interaction.

In one embodiment, a server, a user terminal, and a dialogue operator terminal cooperate over a communication network to implement the claimed system. The server includes at least one processor, a main memory, a non-transitory storage device, and a network interface. The processor executes a control program stored in the storage device to realize functional modules corresponding to statistical learning processing, natural language analysis processing, search processing, prompt sentence generation, generative AI model inference, emotion analysis processing, history management, and terminal control.

The server uses general-purpose computing hardware, such as a multi-core central processing unit and an optional graphics processing unit. The server uses an operating system and a middleware stack including a web framework, a database management system, and a machine learning runtime. For example, the server uses a web application framework to receive and respond to HTTP requests, a relational or document-oriented database to store structured information and history information, and a machine learning framework such as a tensor computation library to execute neural network models. The server further uses a natural language processing library to perform tokenization, syntactic analysis, and entity extraction, and uses an emotion recognition library or model for emotion analysis processing.

The server constructs and executes a program that configures modules implementing the claimed functions. The server configures a training data construction module that reads information from a plurality of information sources. The server treats a product database, a service environment database, a communication route database, and a dialogue history repository as information sources. The server stores these data in structured form, such as tables with fields for product attributes, environment parameters, routing parameters, and dialogue metadata. The server applies data cleaning operations, such as normalization of text fields, removal of invalid records, and type conversion, to prepare a training data set.

The server configures a statistical learning module that uses the training data set to train a plurality of models. In one embodiment, the server trains a neural network model for intent classification, a neural network model for semantic embedding, and a neural network model for emotion recognition. The server uses a supervised learning method in which each training sample consists of an input vector and a target label. The server defines a loss function, such as cross-entropy loss for classification tasks and mean squared error for regression tasks, and updates model parameters by a gradient-based optimization algorithm, such as stochastic gradient descent with momentum or an adaptive moment estimation method. The server applies data augmentation techniques, such as synonym replacement or minor perturbation of sentence structure, to increase the robustness of the models. By repeatedly performing forward propagation and backpropagation over mini-batches of training samples, the server minimizes the loss function and stores the resulting model parameters in the storage device.

The server configures a natural language analysis module that uses the trained intent classification model and a linguistic analysis library. The server receives question sentences from the user terminal and converts them into a token sequence by applying a tokenizer. The server derives part-of-speech tags, dependency structures, and named entities. The server feeds a vector representation of the question sentence into the intent classification neural network, which may be a multi-layer transformer network with self-attention layers. The server obtains a probability distribution over possible intents and selects an intent label, such as a request for product information or a request for return policy. The server also identifies element information, such as product identifiers, policy types, or route identifiers, by combining entity recognition and slot-filling logic. The server encodes these intent and element signals in a structured internal representation stored in memory.

The server configures a search module that operates over the structured information stored in the storage device. The server uses the intent information and the element information as query parameters. The server constructs either a structured query, such as a database query with conditions on product identifiers and policy types, or a semantic search query using vector embeddings. In a semantic search variant, the server uses a sentence embedding model, implemented as a transformer-based encoder, to map both the question sentence and candidate context passages to vectors in a shared space. The server computes cosine similarity scores between the question vector and context vectors. The server selects context information having similarity scores above a threshold or among the top-ranked results and concatenates or otherwise integrates them into a context text of predetermined maximum length. The server may apply a summarization model or rule-based compression to reduce redundancy and fit the context information into a token budget suitable for the generative AI model.

The server configures a prompt generation module that constructs a prompt sentence in a predetermined format. The server uses label information, such as explicit markers

“Question:” and “Context:”, and uses an instruction text to direct the behavior of the generative AI model. In one embodiment, the server generates a prompt sentence as follows:

Question: “What is the return policy for this product?”

Context: “This product can be returned within 30 days after purchase. A proof of purchase is required for returns.”

Using only the information in the context, generate a concise and customer-friendly answer to the question.

In another embodiment, the server generates a prompt sentence for shipping status:

Question: “Please tell me the shipping status of my recent order.”

Context: “Order #12345 was shipped yesterday via standard delivery. The estimated delivery date is three days from shipment.”

Provide a concise answer explaining the current shipping status and expected delivery date.

In yet another embodiment, the server generates a prompt sentence for security information:

Question: “Please explain the recent security issue.”

Context: “The latest security advisory describes a vulnerability that has been patched on all production servers. No user data was exposed.”

Generate an answer that reassures the user while accurately reflecting the context.

The server then encodes the prompt sentence according to the vocabulary and tokenization rules of the generative AI model. In one implementation, the server uses a subword tokenization scheme to transform the prompt sentence into an integer sequence and sends this sequence to the generative AI model.

The server configures the generative AI model as a neural network, for example a transformer-based autoregressive language model with multiple layers of self-attention and feed-forward sublayers. The server sets model hyperparameters, such as the number of layers, attention heads, hidden dimension size, and context window length. During training of the generative AI model, the server defines a likelihood objective over sequences of tokens, uses teacher forcing to compare predicted tokens to ground-truth tokens, and applies a loss function such as negative log likelihood. The server updates the model parameters through gradient descent-based training using mini-batches of prompt-target pairs. During inference, the server executes only forward propagation, computing attention weights and linear transformations layer by layer to produce probability distributions over next tokens.

The server applies decoding algorithms, such as greedy decoding, beam search, or nucleus sampling, to generate a response sentence conditioned on the prompt sentence. The server may control decoding hyperparameters including maximum generation length, temperature, and sampling thresholds. The server applies length limitation processing by truncating the generated token sequence after a predetermined limit and by removing trailing incomplete sentences. The server applies content filtering processing by scanning the generated text for prohibited patterns, low-confidence segments, or contradictions with the input context, and may either mask or replace such portions.

The server configures an emotion analysis module that receives multimodal signals. The server receives voice information as audio samples, character information as transcripts or typed text, and image information as image frames of a user's face. The server extracts acoustic features, such as Mel-frequency cepstral coefficients and prosodic features, from the voice information. The server extracts textual features, such as sentiment scores and polarity indicators, from the character information. The server extracts visual features, such as facial landmarks and action units, from the image information. The server inputs these feature vectors into an emotion recognition neural network, which may be a multimodal architecture combining convolutional layers for images, recurrent or transformer layers for text, and temporal convolution or recurrent layers for audio. The server outputs an emotional state label or a vector of emotion intensities.

The server integrates the emotional state into the prompt generation module and output processing module. When the emotional state indicates dissatisfaction or anger, the server modifies the instruction text in the prompt sentence to require a more apologetic or explanatory tone, and may constrain the generative AI model to produce longer or more detailed responses. When the emotional state indicates satisfaction or calmness, the server modifies the instruction text to encourage concise or affirmative responses and may propose additional options. By adjusting the prompt sentence and response expression based on a quantified emotional state, the server systematically changes internal generation parameters and content selection rather than merely displaying static hints.

The server configures a history management module that records question sentences, context information, prompt sentences, response sentences, and associated emotional states as history information in the storage device. The server structures this history information in indexed tables, with fields for time, user identifiers, intent labels, element information, context identifiers, prompt patterns, model configuration parameters, and emotion scores. The server periodically reuses this history information as part of the training data set for retraining or fine-tuning the intent classifier, the semantic search model, the generative AI model, and the emotion recognition model. Because the server stores these items in a structured manner, the statistical learning module can efficiently retrieve and aggregate examples for specific intents or emotional conditions and can thereby improve the performance of the models without manual curation.

The server configures a terminal control module that communicates with the user terminal and the dialogue operator terminal. The server sends response sentences to the user terminal as display text and sends supplementary information, such as selected context passages and answer candidates, to the dialogue operator terminal. On the dialogue operator terminal, a display subsystem presents these data in a unified view, enabling an operator to quickly confirm, edit, or select generated responses. The server uses event-driven communication with both terminals to reduce unnecessary polling and to minimize network bandwidth caused by redundant updates.

The user terminal includes a processor, a display, at least one input device such as a touch panel or keyboard, a microphone, and optionally a camera. The user terminal executes an application that displays an input field, collects the question sentence, and transmits it to the server via a network stack. The user terminal receives the response sentence from the server and displays it on the display. Optionally, the user terminal collects voice information and image information and forwards these signals to the server for emotion analysis processing.

The user uses the user terminal to read the responses and to input further questions.

The dialogue operator terminal includes a processor, a display, and input devices. The dialogue operator terminal executes an application that receives from the server supplementary information, answer candidates, and emotion-related indicators. The dialogue operator terminal displays these elements in association with the current dialogue, for example in a multi-pane interface where one pane shows the user's question and emotion, another pane shows the system-generated answer candidate, and a third pane shows relevant policy or product details. The dialogue operator can accept a candidate as-is, modify it, or compose a new answer while viewing the supplementary information. The dialogue operator terminal then transmits any finalized answer to the user, either through the server or directly through messaging infrastructure, depending on the architecture.

By organizing the above modules and data flows, the server improves computer technology in several manners. The server reduces the number of database accesses and model invocations by tightly coupling natural language analysis, search processing, and prompt sentence generation: because context information is pre-filtered and encoded in a format optimized for the generative AI model, the server avoids repeated trial-and-error generations and redundant queries. The use of semantic embeddings for context selection reduces the search space and shortens retrieval time compared with broad keyword-based search. The integration of emotion analysis into internal generation control improves the initial response quality, which reduces the number of turns and the amount of network traffic between terminals and the server. The structured recording and reuse of history information enable incremental learning without full retraining, thereby improving convergence speed and reducing compute resource consumption.

Furthermore, the server uses non-conventional rules and procedures for processing. Unlike a simple rule engine that maps keywords to canned responses, the server constructs a prompt sentence that encodes both question and context with label information and instruction text, and modifies this prompt sentence based on a quantified emotional state. This non-standard prompt construction rule, coupled with an emotion-aware adjustment loop, changes the internal operation of the generative AI model, resulting in different token probability distributions and, therefore, different computational paths inside the transformer network.

The server thereby realizes a technical effect of improved accuracy and stability of generated responses by explicit control of model inputs and not by mere high-level instructions.

In alternative embodiments, the server may use different types of generative AI models, such as encoder-decoder architectures, recurrent neural networks, or mixture-of-experts models, provided that the models accept a prompt sentence and output a response sentence. The server may also employ different emotion recognition architectures, such as purely text-based models or purely audio-based models, depending on the available input modalities. The server may further vary the structure of the prompt sentence, the types of label information, and the instruction text to target different applications, such as technical support, navigation assistance, or educational tutoring, while maintaining the core mechanism of combined context retrieval, structured prompt construction, and emotion-aware adjustment.

In all these embodiments, the server, the user terminal, and the dialogue operator terminal cooperate to implement concrete data structures and algorithmic steps that improve the underlying functioning of the computer system, including faster retrieval, more efficient memory utilization, reduced unnecessary network traffic, and higher-quality response generation.

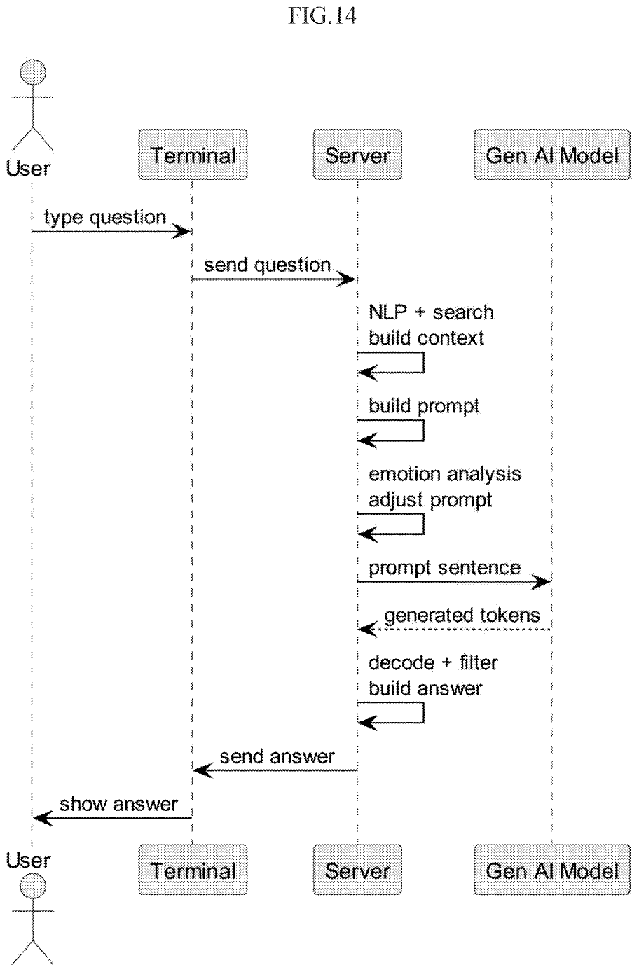

The following describes the processing flow using FIG. 14.

### Step 1

User operates the terminal to input a question.

User touches an input area on the terminal display and types a natural language question, such as “What is the return policy for this product?”.

Input: raw key events and touch events from the terminal's input device.

Terminal converts these events into a UTF-8 text string, trims whitespace, and performs basic validation (for example, checking that the length is greater than zero).

Output: a validated question string and optional metadata (such as product identifier, language code, and timestamp) held in the terminal's memory.

### Step 2

Terminal constructs and transmits a request to the server.

Terminal builds a data structure containing the question string and metadata, and serializes this data structure into a request message according to a communication protocol.

Input: the validated question string and metadata from Step 1.

Terminal performs data formatting (for example, encoding characters, packaging fields) and network-layer encapsulation, and then sends the message through a communication interface to a predefined server address.

Output: a network request containing the question information transmitted over a communication network to the server.

### Step 3

Server receives the request and parses the question.

Server listens on a network port, accepts the incoming request, and passes the payload to an application-layer handler.

Input: the network request containing the serialized question and metadata received via the network interface.

Server decapsulates protocol headers, deserializes the payload, and converts the encoded data into internal representations, such as a Unicode string for the question and structured records for the metadata.

Output: an internal request object containing the question sentence, user-related information, and context identifiers stored in the server's memory.

### Step 4

Server performs natural language analysis on the question.

Server invokes a natural language processing module to interpret the question sentence.

Input: the question sentence string from the request object of Step 3.

Server tokenizes the string into a sequence of tokens, assigns part-of-speech tags, and identifies syntactic dependencies using a linguistic analysis library. Server further feeds a vector representation of the sentence into an intent classification model and a slot extraction model. Through vector multiplications and nonlinear activation functions, the models output probabilities and slot labels.

Output: intent information (such as intent category) and element information (such as product identifier or policy type) encoded as structured data fields linked to the request.

### Step 5

Server retrieves relevant context information from stored data.

Server uses the intent information and element information to search in one or more data repositories.

Input: intent label and element values produced in Step 4.

Server constructs a search query, either as a structured database query or as a vector similarity query. For semantic search, Server computes an embedding vector for the question and for candidate documents using a neural embedding model, then applies vector arithmetic (for example, cosine similarity) to rank candidates. For structured search, Server evaluates conditional expressions on indexed fields.

Output: one or more context information items (for example, text passages describing policies or product details) selected and ranked as candidate support data for answering the question.

### Step 6

Server integrates and trims the context information.

Server processes the set of candidate context items to prepare a single context text suitable for later generation.

Input: the list of selected context information items from Step 5.

Server concatenates or merges these text passages, removes duplicate or low-relevance segments, and enforces a length constraint by truncating or summarizing the content. For summarization, Server may compute importance scores for sentences and select a subset with highest scores.

Output: a consolidated context text string with bounded length and high relevance to the question stored as part of the internal request state.

### Step 7

Server constructs a prompt sentence for the generative AI model.

Server combines the question and the context into a structured textual instruction.

Input: the original question sentence from Step 3 and the consolidated context text from Step 6.

Server attaches label markers such as “Question:” and “Context:”, and appends an instruction line that defines constraints on answer style or length. This involves string concatenation operations and insertion of control phrases.

Output: a prompt sentence text, such as:

Question: “What is the return policy for this product?”

Context: “This product can be returned within 30 days after purchase. A proof of purchase is required for returns.”

Using only the information in the context, generate a concise and customer-friendly answer to the question.

### Step 8

Server analyzes user emotion to adjust the prompt or expected response.

Server evaluates multimodal input to determine an emotional state and modifies the generation configuration accordingly.

Input: voice information, character information, and image information captured from previous or current interactions and associated with the current request.

Server extracts features (such as acoustic parameters, textual sentiment indicators, and facial action units), feeds them into an emotion recognition model, and obtains an emotion label or intensity scores. Based on these scores, Server decides whether to adjust the instruction part of the prompt sentence or to set response tone parameters (for example, more explanatory or more reassuring).

Output: an emotional state indicator and an updated version of the prompt sentence or associated control parameters that reflect emotion-sensitive behavior.

### Step 9

Server encodes the prompt sentence and invokes the generative AI model.

Server prepares the prompt sentence for processing by the generative AI model.

Input: the (possibly emotion-adjusted) prompt sentence from Step 7 or Step 8.

Server converts the prompt sentence into a sequence of tokens using a tokenizer, maps tokens to integer identifiers, and constructs input tensors. Server then passes these tensors into the generative AI model, which internally performs matrix multiplications, attention weight calculations, and non-linear transformations to compute probability distributions over next tokens in the sequence.

Output: a sequence of token identifiers representing a generated response draft from the generative AI model.

### Step 10

Server decodes and post-processes the generated response.

Server converts the token sequence into a human-readable response and refines it.

Input: the sequence of token identifiers produced in Step 9.

Server maps token identifiers back to text fragments and concatenates them into a response string. Server then applies length limitation by truncating exceeding portions and applies content filtering by scanning for undesired phrases or contradictions with the context. If necessary, Server removes or replaces flagged segments based on predefined rules.

Output: a cleaned response sentence in natural language, such as “You can return this product within 30 days after purchase.”, stored in association with the request.

### Step 11

Server prepares data for the dialogue operator terminal and the user terminal.

Server derives supplementary information and answer candidates for operator support and final display.

Input: the response sentence from Step 10, the context information from Step 6, and the emotional state from Step 8.

Server selects key parts of the context text, associates them with the response sentence as supplementary information, and formats a display bundle that includes the response sentence, additional details, and emotion indicators. Server separately prepares a response package for the user terminal, containing at least the final response sentence and minimal metadata.

Output: a first data structure for the dialogue operator terminal and a second data structure for the user terminal, ready for transmission.

### Step 12

Server records interaction history for future learning.

Server stores all relevant fields of the interaction as history information.

Input: the question sentence, context information, prompt sentence, response sentence, emotional state, model configuration parameters, and timestamps from preceding steps.

Server writes these values into structured history tables in the storage device, possibly indexing them by intent and emotion. Server may also compress or encode large text fields for efficient storage.

Output: a persistent history record that can be retrieved later as part of a training data set for retraining or fine-tuning models.

### Step 13

Server sends results to the terminals.

Server uses the communication interface to deliver the prepared data structures.

Input: the operator-oriented data structure and the user-oriented data structure from Step 11.

Server serializes each structure into a transmission format and sends them to the respective terminals over the network. The server may perform batching or compression of messages to reduce bandwidth.

Output: network responses delivered to the dialogue operator terminal and the user terminal containing the response sentence and associated information.

### Step 14

Dialogue operator terminal displays supplementary information and answer candidates.

Dialogue operator terminal processes the received operator-oriented data to assist human handling.

Input: the operator-oriented response data received from the server in Step 13.

Dialogue operator terminal parses the data, populates display components with the response sentence, context snippets, and emotion indicators, and renders them on a screen for the operator. The terminal may also allow editing of the suggested response before it is transmitted to the user.

Output: a rendered user interface presenting the answer candidate and supporting information to the dialogue operator.

### Step 15

User terminal displays the system's response.

User terminal uses the received data to inform the user of the answer.

Input: the user-oriented response data received from the server in Step 13.

User terminal parses the response sentence, inserts it into a display layout such as a message bubble, and updates the screen while removing any previous loading indicator.

Output: a rendered answer on the user terminal display that the user can read and evaluate.

### Step 16

User reviews the answer and optionally initiates a follow-up.

User uses the information provided by the system to decide on next actions.

Input: the displayed response sentence shown on the user terminal in Step 15.

User reads the answer, determines whether additional information is required, and either ends the interaction or enters a new question, thereby producing new input events for the terminal.

Output: either completion of the current interaction or new user input that triggers repetition of the processing flow beginning from Step 1.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

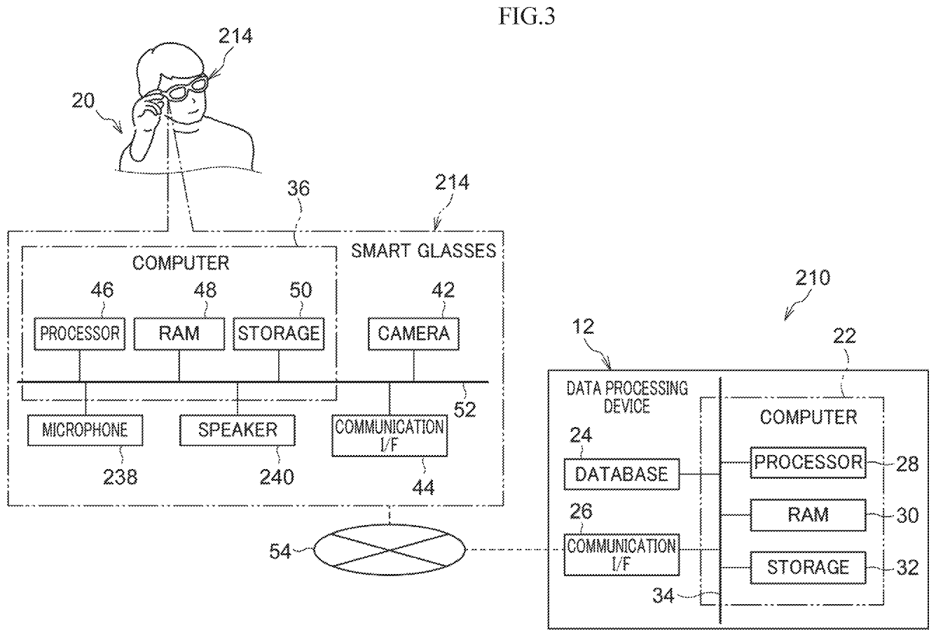

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

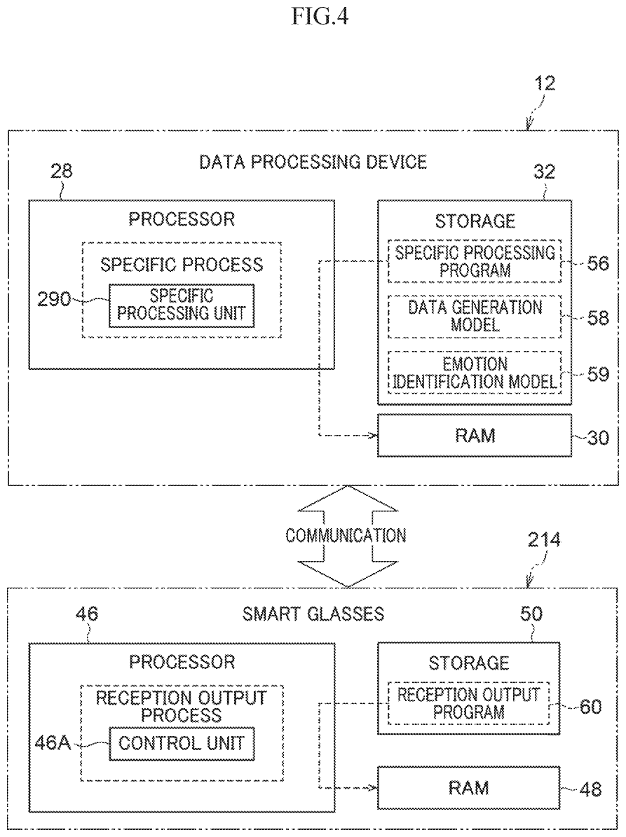

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

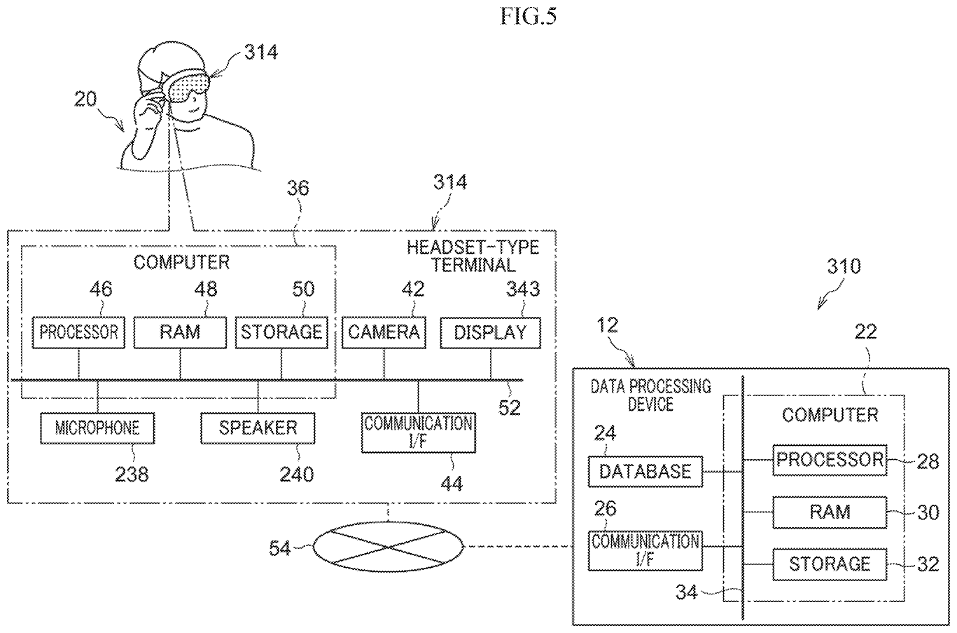

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

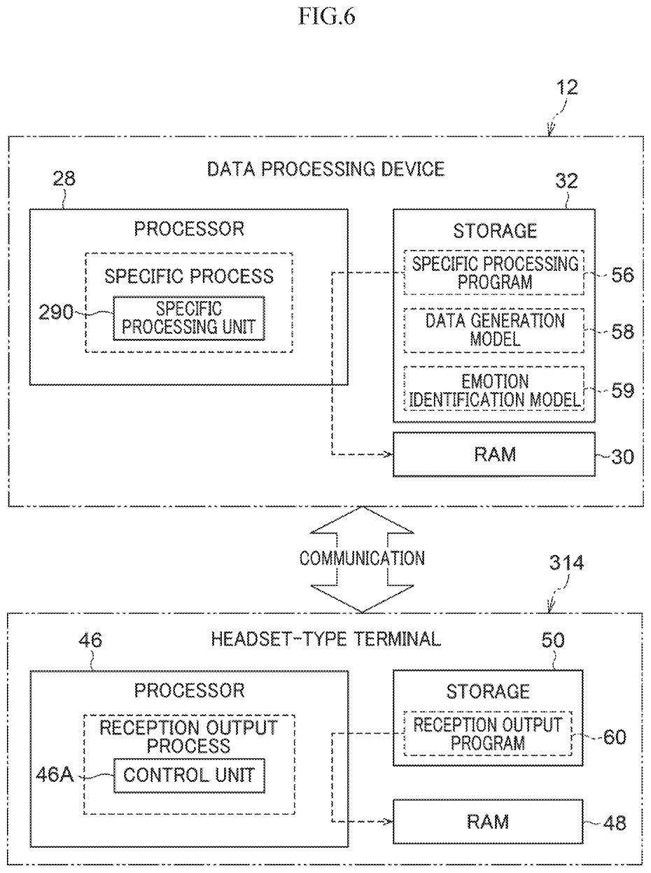

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

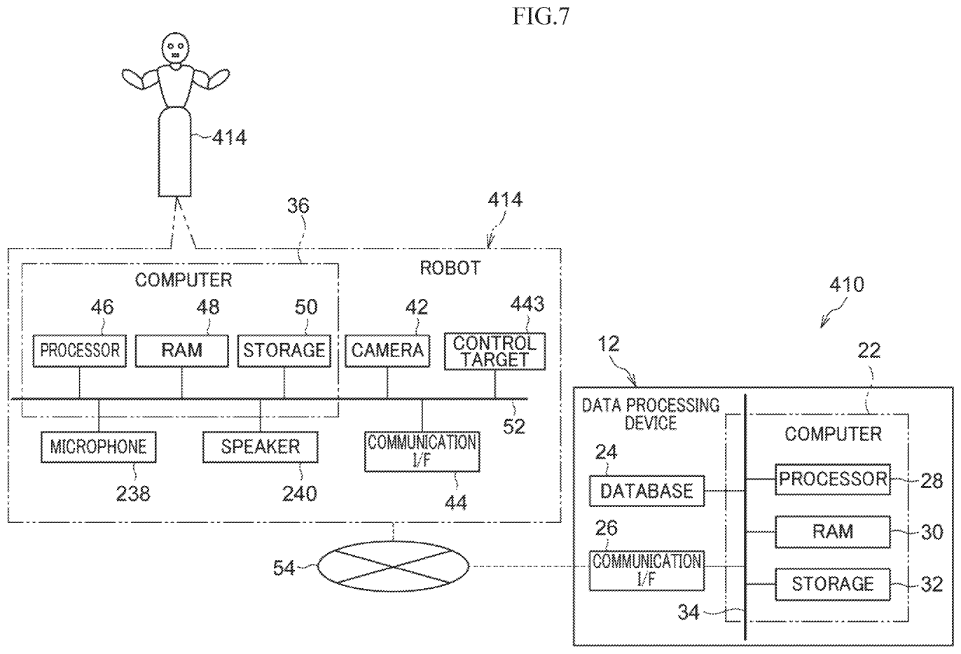

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

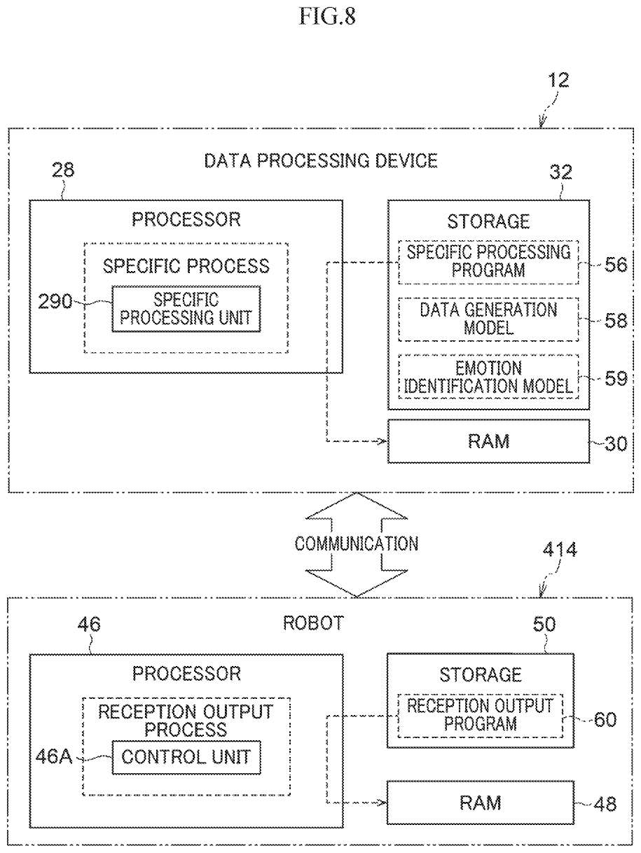

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

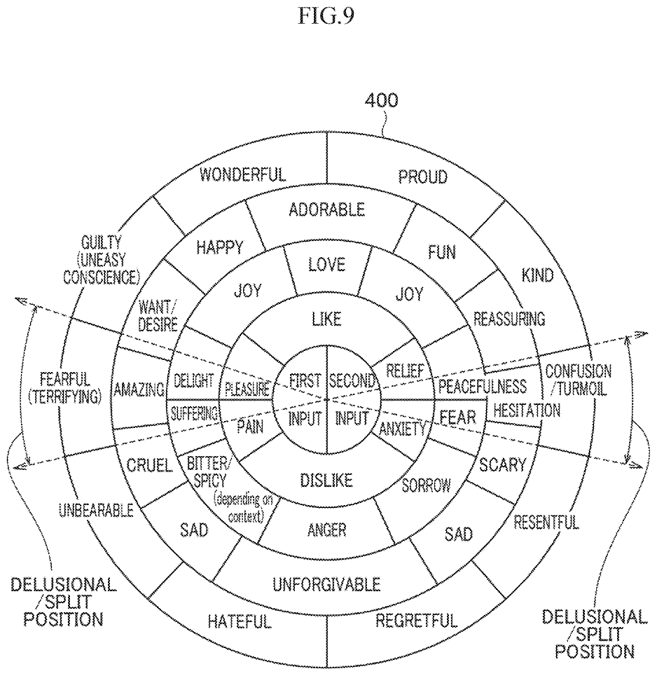

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

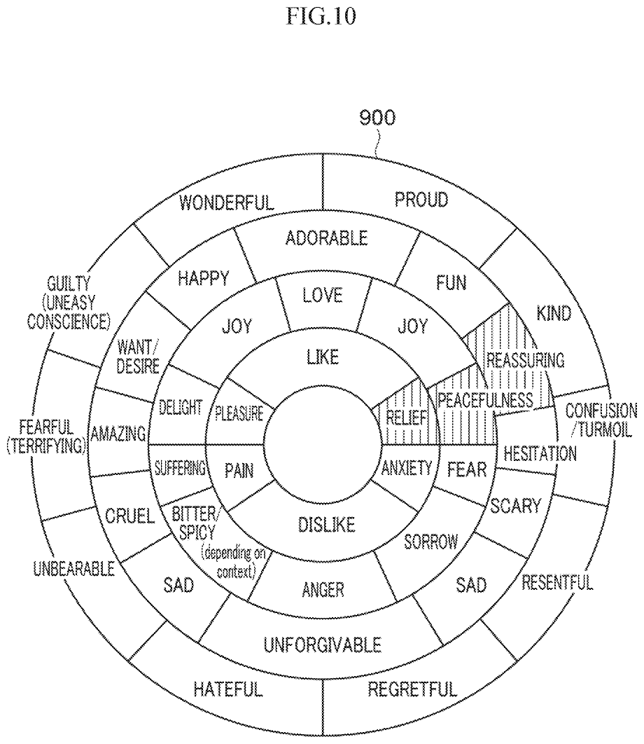

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, via a communication network, structured data and unstructured data from a plurality of information sources and store the acquired data in a storage device,
perform preprocessing on the acquired data, the preprocessing including missing-value completion, normalization, encoding, and feature extraction, and generate a training dataset and an evaluation dataset,
train, by using the training dataset, a learned model including at least one of an identification model and a prediction model based on a machine learning algorithm including deep learning, and verify the learned model by calculating evaluation indices based on the evaluation dataset,
analyze a prompt sentence represented in natural language and received from a user, identify a requested task based on the prompt sentence, and extract related data corresponding to the requested task from the acquired data and/or the learned model,
automatically generate a prompt sentence to be supplied to a generative artificial intelligence model, the generated prompt sentence including at least part of the user prompt sentence and the extracted related data as input conditions, and input the generated prompt sentence into the generative artificial intelligence model to cause the generative artificial intelligence model to generate one or more response candidates,
estimate, based on input content from the user and operation history of the user with respect to the response candidates, an emotional state or an evaluation of the user, and dynamically adjust at least one of content of the prompt sentence supplied to the generative artificial intelligence model and generation conditions of the generative artificial intelligence model in accordance with an estimation result so as to optimize the response candidates,
transmit optimized response candidates to a terminal device for presentation of information or operational support to an end user or an operator, and
store, as history data, the user prompt sentence, the response candidates, and the estimated emotional state or evaluation, and reuse the history data in the training dataset to continuously retrain the learned model and the generative artificial intelligence model.

### Supplementary 2

The system according to supplementary 1,
wherein the processor is configured to
store, in the storage device, as the plurality of information sources, product-related information including attribute information of articles, site-related information including usage history of network resources, communication navigation information including transition history of communication paths, and user interaction logs including dialogue history, and preprocess the stored information to generate the training dataset and the evaluation dataset.

### Supplementary 3

The system according to supplementary 1,
wherein the processor is configured to
control speed and accuracy of information provision such that a plurality of evaluation indices including a response-quality index, a customer-satisfaction index, and an operator-load index satisfy predetermined conditions, by automatically generating and dynamically adjusting the prompt sentence supplied to the generative artificial intelligence model, thereby contributing to efficiency of a work process and improvement of user experience.

### Application Example 1

### Supplementary 1

A system comprising a processor,
wherein the processor is configured to
collect information including behavior history information and attribute information from a plurality of information sources, execute preprocessing and feature generation processing on the collected information to construct a training data set, and train a machine learning model for estimating recommendation target items based on the training data set; and
acquire, from a terminal, a user question and a conversation history, execute natural language processing based on the user question and the conversation history, generate and input a prompt sentence for causing a generative AI model to generate an answer text, and output the answer text obtained from the generative AI model to the terminal; and
acquire, from the terminal, a user behavior history and a current browsing status, calculate candidate recommendation target items by using the machine learning model, generate a prompt sentence including the candidate recommendation target items and a user behavior summary, input the prompt sentence into the generative AI model, and generate a recommendation target item list based on explanation information or ranking information acquired from the generative AI model; and
acquire conversation information in the form of voice or text, execute speech recognition processing and emotion analysis processing to estimate intentions and emotional states of a user and a responder, generate a prompt sentence including an estimation result, input the prompt sentence into the generative AI model, and present response candidates and supplementary information acquired from the generative AI model on a display screen for the responder; and
transmit the recommendation target item list and the answer text as structured information to the terminal, provide, on the terminal, recommendation information and response information visually presented to the user, and store user selection operations and purchase operations as behavior history; and
execute, periodically or under a predetermined condition, an update process in which the stored behavior history is used as an additional training data set and is reflected in the machine learning model and in a prompt generation logic for the generative AI model.

### Supplementary 2

The system according to supplementary 1,
wherein the processor is configured to
store, in an information storage device, information related to items, information related to a usage environment, information related to a communication path, and information related to a response history, execute preprocessing processing, feature generation processing, and analysis processing by a machine learning algorithm based on the information stored in the information storage device, and include an analysis result in the prompt sentence to be input into the generative AI model.

### Supplementary 3

The system according to supplementary 1,
wherein the processor is configured to
provide information contributing to improvement of response quality, improvement of user satisfaction, and reduction of responder load by using the recommendation target item list and the response candidates, and realize real-time and high-accuracy information provision adapted to the user behavior history and a current situation by dynamic generation of the prompt sentence using the generative AI model and by calculation of the recommendation target items using the machine learning model.

### Example 2

### Supplementary 1

A system comprising a processor,
wherein the processor is configured to
collect structured or unstructured information obtained from a plurality of information sources and construct a training information set by using a statistical learning method, analyze a natural language inquiry sentence from a user, the natural language inquiry sentence being acquired via a terminal device, by normalizing the natural language inquiry sentence using a character string processing function and a natural language analysis method, and generate analyzed text data by performing removal of unnecessary characters and formatting of a sentence structure,
extract an intention of the inquiry and related information on the basis of the analyzed text data, generate a prompt sentence including the intention and the related information on the basis of template information, and dynamically construct the prompt sentence to be used as input to a generative AI model,
transmit the prompt sentence to the generative AI model disposed externally or internally via a communication mechanism, and acquire a response text generated by the generative AI model on the basis of the prompt sentence,
perform post-processing on the response text, the post-processing including character string formatting, notation unification, and grammar checking, and generate a final response text that is presentable to the terminal device, and
transmit the final response text to the terminal device via a communication path and cause the terminal device to present the final response text to the user.

### Supplementary 2

The system according to supplementary 1,
wherein the processor is configured to
store information related to a product, information related to an information-providing site, information related to communication guidance, and a user interaction record in an information storage device, analyze the information in the information storage device by the statistical learning method to update the training information set, and improve contents of the prompt sentence and the response text on the basis of the updated training information set.

### Supplementary 3

The system according to supplementary 1,
wherein the processor is configured to
control a structure of the prompt sentence and input conditions to the generative AI model so as to contribute to improvement of response speed of inquiry processing, improvement of information-providing quality, and reduction of workload of a person engaged in support operations, and realize rapid and high-accuracy information provision to the user by prompt sentence generation and response post-processing using the generative AI model.

### Application Example 2

### Supplementary 1

A system comprising a processor,
wherein the processor is configured to
collect information from a plurality of information sources and construct a training data set by statistical learning processing,
perform natural language analysis processing on a question sentence transmitted from a user terminal to preprocess the question sentence and to extract intent information and element information,
execute search processing based on the intent information and the element information to acquire context information related to the question sentence from an information set stored in a storage device, and integrate the context information into a predetermined length,
generate, in a predetermined format, a prompt sentence including the question sentence and the context information and further including label information and an instruction text, and input the prompt sentence to a generative AI model,
generate, by probabilistic inference processing of the generative AI model, a response sentence corresponding to the prompt sentence, and perform length limitation processing and content filtering processing on the response sentence,
analyze voice information, character information, and image information of a user by emotion analysis processing to specify an emotional state, and adjust contents of the prompt sentence input to the generative AI model or an expression of the response sentence in accordance with the emotional state,
cause a dialogue operator terminal to display supplementary information and an answer candidate on the basis of the response sentence and the emotional state to support dialogue handling by a dialogue operator, and transmit and display the response sentence to the user terminal, and
record the question sentence, the context information, the prompt sentence, and the response sentence as history information and reuse the history information in the statistical learning processing.

### Supplementary 2

The system according to supplementary 1,
wherein the processor is configured to store information relating to a product, information relating to a service providing environment, information relating to a communication route, and information relating to a dialogue history as structured information in the storage device, and to perform the statistical learning processing and the search processing on the structured information.

### Supplementary 3

The system according to supplementary 1,
wherein the processor is configured to improve a quality of dialogue handling, improve user satisfaction, and reduce a workload of the dialogue operator by generation of the prompt sentence and by adjustment of the prompt sentence or the response sentence in accordance with the emotional state.

What is claimed is:

1. A system comprising:
circuitry configured to:
receive, via a communication interface coupled to a packet-switched network, structured data and unstructured data from a plurality of data sources, and store the received data in a storage device;
execute a preprocessing pipeline on the stored data, the preprocessing pipeline including missing-value completion, normalization, encoding, and feature extraction, to generate a training dataset and an evaluation dataset;
train a learned model using the training dataset, the learned model comprising at least one of an identification model and a prediction model based on a deep learning algorithm, and verify the learned model by computing evaluation indices using the evaluation dataset;
receive a prompt sentence expressed in natural language from a terminal device, identify a requested task based on the prompt sentence, and extract task-related data from at least one of the stored data and the learned model;
generate, using a generative neural network model, a response-generation prompt sentence incorporating the received prompt sentence and the task-related data, and input the response-generation prompt sentence to the generative neural network model to generate one or more response candidates;
estimate, based on input content from the terminal device and operation history data, a user state parameter; and
dynamically adjust at least one of content of the response-generation prompt sentence or generation conditions of the generative neural network model based on the user state parameter to optimize the response candidates, and transmit the optimized response candidates to the terminal device.

2. The system according to claim 1, wherein the circuitry is configured to acquire the structured data and the unstructured data from a plurality of information sources via the communication interface, and store the structured data and the unstructured data as a unified data repository in the storage device prior to execution of the preprocessing pipeline.

3. The system according to claim 2, wherein the circuitry is configured to apply a feature-extraction algorithm to the stored data to derive numerical descriptors, partition the derived numerical descriptors into the training dataset and the evaluation dataset according to a predefined partition ratio, and store the training dataset and the evaluation dataset in the storage device.

4. The system according to claim 3, wherein the circuitry is configured to compute at least one evaluation index from the evaluation dataset to assess performance of the learned model, determine whether the at least one evaluation index satisfies a quality threshold, and trigger retraining of the learned model when the quality threshold is not satisfied.

5. The system according to claim 4, wherein the circuitry is configured to store, as history data in the storage device, the received prompt sentence, the response candidates, and the user state parameter, and incorporate the history data into the training dataset to continuously retrain at least one of the learned model and the generative neural network model.

6. The system according to claim 1, wherein the circuitry is configured to apply a natural language processing algorithm to the received prompt sentence to identify the requested task, retrieve the task-related data by executing a query against the storage device using task identification output as a retrieval parameter, and construct the response-generation prompt sentence by combining a prompt template with the retrieved task-related data.

7. The system according to claim 6, wherein the circuitry is configured to generate a plurality of response candidates from the generative neural network model in response to the response-generation prompt sentence, rank the plurality of response candidates based on a response-quality index computed from the user state parameter and the operation history data, and select a highest-ranked response candidate for transmission to the terminal device.

8. The system according to claim 7, wherein the circuitry is configured to receive selection feedback data from the terminal device indicating a user selection among the plurality of response candidates, update the user state parameter based on the selection feedback data, and adjust the generation conditions of the generative neural network model based on the updated user state parameter.

9. The system according to claim 8, wherein the circuitry is configured to compute a response-quality index, a satisfaction index, and a load index from the stored history data, and output the computed indices as performance monitoring data.

10. The system according to claim 1, wherein the circuitry is configured to receive operation history data recording prior interactions of a user with the terminal device, apply an estimation model to the received prompt sentence and the operation history data to generate the user state parameter representing an affective state of the user, and select adjustment parameters for the generative neural network model based on the user state parameter.

11. The system according to claim 10, wherein the circuitry is configured to determine, based on the user state parameter, at least one of a maximum output length, a sampling method parameter, or a stylistic control parameter for the generative neural network model, and supply the determined parameters as generation conditions to the generative neural network model.

12. The system according to claim 11, wherein the circuitry is configured to detect a change in the user state parameter exceeding a state-change threshold between consecutive interactions, regenerate the response-generation prompt sentence to incorporate updated contextual data reflecting the changed user state parameter, and input the regenerated response-generation prompt sentence to the generative neural network model.

13. The system according to claim 1, wherein the circuitry is configured to store, in the storage device, first attribute data comprising structured records describing categories, attributes, and states of items associated with a plurality of service categories, second attribute data comprising access-pattern logs associated with network resources, and interaction sequence data comprising transition records of communication flows, and use the stored data as information sources for the preprocessing pipeline.

14. The system according to claim 13, wherein the circuitry is configured to identify, from the received prompt sentence, a service category associated with the requested task, retrieve first attribute data and interaction sequence data corresponding to the identified service category from the storage device, and incorporate the retrieved data into the response-generation prompt sentence as task context.

15. The system according to claim 1, wherein the circuitry is configured to receive escalation data from the terminal device indicating that a response candidate requires human review, route the escalation data together with relevant history data to a designated operator terminal, and update the operation history data with a record of the escalation event.

16. The system according to claim 1, wherein the circuitry is configured to apply a continuous retraining algorithm that periodically samples stored history data, constructs incremental training batches from the sampled history data, and updates parameters of at least one of the learned model and the generative neural network model using the incremental training batches.

17. The system according to claim 1, wherein the circuitry is configured to generate, using the generative neural network model, a prompt sentence for instructing the generative neural network model to adjust response content based on the user state parameter, input the generated prompt sentence to the generative neural network model, and output an adjusted response candidate for transmission to the terminal device.

18. A system comprising:
circuitry configured to:
receive, via a communication interface coupled to a packet-switched network, input data comprising a prompt sentence and operation history data from a terminal device;
apply a natural language processing algorithm to the prompt sentence to identify a requested task, and retrieve task-related data from a storage device using task identification output as a retrieval parameter;
generate a response-generation prompt sentence by combining a prompt template with the task-related data and input the response-generation prompt sentence to a generative neural network model to produce response candidates;
estimate a user state parameter based on the prompt sentence and the operation history data using an estimation model; and
dynamically adjust at least one of content of the response-generation prompt sentence or generation conditions of the generative neural network model based on the user state parameter, and transmit optimized response candidates to the terminal device.

19. The system according to claim 18, wherein the circuitry is configured to store the prompt sentence, the response candidates, and the user state parameter as history data in the storage device, and incorporate the history data into a training dataset to retrain at least one of a learned model and the generative neural network model.

20. A method performed by circuitry, the method comprising:
receiving, via a communication interface coupled to a packet-switched network, structured data and unstructured data from a plurality of data sources, and storing the received data in a storage device;
executing a preprocessing pipeline on the stored data, the preprocessing pipeline including missing-value completion, normalization, encoding, and feature extraction, to generate a training dataset and an evaluation dataset;
training a learned model using the training dataset, the learned model comprising at least one of an identification model and a prediction model based on a deep learning algorithm, and verifying the learned model by computing evaluation indices using the evaluation dataset;
receiving a prompt sentence expressed in natural language from a terminal device, identifying a requested task based on the prompt sentence, and extracting task-related data from at least one of the stored data and the learned model;
generating, using a generative neural network model, a response-generation prompt sentence incorporating the received prompt sentence and the task-related data, and inputting the response-generation prompt sentence to the generative neural network model to generate one or more response candidates;
estimating, based on input content from the terminal device and operation history data, a user state parameter; and
dynamically adjusting at least one of content of the response-generation prompt sentence or generation conditions of the generative neural network model based on the user state parameter to optimize the response candidates, and transmitting the optimized response candidates to the terminal device.
